(19) United States
(12) Patent Application Publication
(10) Pub. No.: US 2024/0209144 A1
(43) Pub. Date: Jun. 27, 2024

(54) RESIN, RESIN COMPOSITION, COATING LIQUID COMPOSITION, FILM, COATING MEMBRANE, ELECTROPHOTOGRAPHY PHOTORECEPTOR, INSULATIVE MATERIAL, MOLDED PRODUCT, ELECTRONIC DEVICE, AND RESIN MANUFACTURING METHOD

(71) Applicant: IDEMITSU KOSAN CO.,LTD., Tokyo (JP)

(72) Inventors: Takaaki HIKOSAKA, Tokyo (JP); Hironobu MORISHITA, Tokyo (JP); Kazunori CHIBA, Tokyo (JP)

(73) Assignee: IDEMITSU KOSAN CO.,LTD., Tokyo (JP)

(21) Appl. No.: 18/284,967

(22) PCT Filed: Mar. 31, 2022
(86) PCT No.: PCT/JP2022/016887

§ 371 Date: Jan. 18, 2024

(30) Foreign Application Priority Data
Apr. 1, 2021 (JP) 2021-063179

(51) Int. Cl. C08G 64/06; C08G 64/42; C09D 169/00; G03G 5/05

(52) U.S. Cl. CPC C08G 64/06; C08G 64/42; C09D 169/00; G03G 5/0564

(57) ABSTRACT

A resin includes a repeating unit of a structure represented by a formula (FR1) below. In the formula (FR1), R are each independently an aliphatic hydrocarbon group having 1 to 6 carbon atoms, an aromatic hydrocarbon group having 6 to 12 ring carbon atoms, an alkoxy group having 1 to 10 carbon atoms, or a halogen atom; a plurality of R are optionally linked together to form a cyclic structure (including an aromatic ring and a heterocycle); and n represents an integer in a range from 0 to 3.

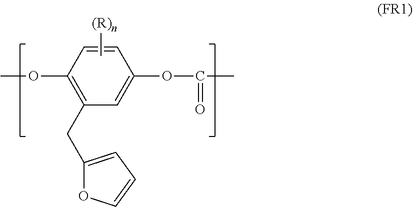

### TECHNICAL FIELD

The present invention relates to a resin, a resin composition, a coating liquid composition, a film, a coating film, an electrophotographic photoreceptor, an insulative material, a molded product, an electronic device, and a method of producing a resin.

### BACKGROUND ART

Polycarbonate resins have been used in various industrial fields as materials for molded products because of their excellent mechanical, thermal, and electrical properties. In recent years, polycarbonate resins have been used extensively in the field of functional products that also utilize optical properties and other properties of the polycarbonate resins. With the expansion of the field of such applications, performance requirements for polycarbonate resins have been diversifying, so that not only conventional polycarbonate resins but also polycarbonate resins with various chemical structures have been proposed.

An example of such functional products is an organic electrophotographic photoreceptor in which a polycarbonate resin is used as a binder resin for functional materials such as a charge generating material and a charge transporting material.

The organic electrophotographic photoreceptor is required to have predetermined sensitivity and electrical and optical properties depending on an electrophotographic process to be applied. A surface of a photosensitive layer of the electrophotographic photoreceptor is repeatedly subjected to operations such as corona charging, toner development, transfer to paper, and cleaning treatment. Thus, electrical or mechanical external-force is applied thereto every time such operations are performed. The photosensitive layer provided on the surface of the electrophotographic photoreceptor is therefore required to be durable against such an external force in order to maintain image quality of electrophotography over a long period of time. The organic electrophotographic photoreceptor is also required to have solubility and stability in organic solvents because the organic electrophotographic photoreceptor is typically produced by dissolving a binder resin together with functional materials in an organic solvent and then casting into a film on a conductive substrate or the like.

A binder resin that has been used conventionally for the photoreceptor is a polycarbonate resin made from 2,2-bis(4-hydroxyphenyl)propane, 1,1-bis(4-hydroxyphenyl)cyclohexane, or the like, but such conventional polycarbonate resins have been unsatisfactory in terms of satisfying durability. One possible way to improve the durability is to improve wear resistance of the photosensitive layer. An effective known technique for improving the wear resistance of the photosensitive layer is to introduce a reactive functional group to a polycarbonate and modify the polycarbonate through a polymer reaction.

As an example of the polymer reaction, Patent Literature 1, concerning a resin described therein, discloses a technique of cross-linking a PC having an allyl group by using a radical initiator, and indicates that the resultant resin had a mechanical strength (tensile strength, etc.) better than that of a bisphenol A type polycarbonate resin.

Patent Literature 2, concerning a polycarbonate copolymer, describes a resin obtained by cross-linking a polycarbonate resin having an epoxy group or the like with an ionic mechanism. Patent Literature 3 describes a cross-linking technique performed by reacting a polycarbonate having a double bond with a compound having multiple silicon-hydrogen bonds in the presence of a platinum catalyst, and a cross-linking technique performed by reacting a polycarbonate having a double bond with a compound having an alkoxy group and hydrogen on a silicon atom in the presence of a platinum catalyst and thereafter performing hydrolysis and condensation reaction.

Patent Literature 4 discloses a cross-linking technique in which a polycarbonate having an allyl group, while being heated from 120 degrees C. to 260 degrees C., is irradiated with an electron beam.

Patent Literature 5 discloses a cross-linking method in which a polycarbonate having an allyl group is used together with a triarylamine having a specific structure and with a radical polymerizable compound having no triarylamine structure, and is heated without using catalysts.

Patent Literature 6 reports a resin whose chain length is extended with a bismaleimide, the resin having an anthracene skeleton at a terminal of an aliphatic-aromatic polyester.

Patent Literature 7 discloses a cross-linked resin obtained through a reaction of a polyfunctional maleimide with an aliphatic polyester, polyamide or polyurea having a furan structure.

Non-Patent Literature 1 discloses a resin produced by cross-linking, with a bifunctional maleimide compound, an aliphatic-aromatic polyester resin in which an anthracenedicarboxylic acid skeleton is partially introduced.

### CITATION LIST

### Patent Literature(s)

Patent Literature 1: JP H10-77338 A
Patent Literature 2: JP H9-319102 A
Patent Literature 3: JP 2000-44668 A
Patent Literature 4: JP 2007-314719 A
Patent Literature 5: JP 2010-72019 A
Patent Literature 6: JP 2003-286347 A
Patent Literature 7: U.S. Pat. No. 3,435,003

### Non-Patent Literature(s)

Non-Patent Literature 1: Macromolecules 1999, 32, 5786 to 5792

### SUMMARY OF THE INVENTION

### Problem(s) to Be Solved by the Invention

Problems with the polycarbonate described in Patent Literature 1 are that the charge transporting material (CTM) is degraded by the use of the radical initiator and the added initiator remaining on the photoreceptor causes an increase in residual potential in use as the photoreceptor.

The polycarbonate described in Patent Literature 2 has problems in that since a compound having a nucleophilic group such as an amino group, or an acidic group such as a carboxylic anhydride group is used in initiation reaction, the CTM is deteriorated, and that the added compound remains in the photoreceptor, resulting in an increase in residual potential in use as the photoreceptor. Further, Patent Literature 2 has no description verifying that the resin disclosed therein was cross-linked and fails to clarify whether the effect of the improvement in physical properties disclosed therein was derived from a cross-linked structure.

The polycarbonate described in Patent Literature 3 has problems in that the use of the platinum catalyst deteriorates the CTM and that the added catalyst remaining on the photoreceptor causes an increase in residual potential in use as the photoreceptor. In addition, it is difficult to inhibit reaction in the coating liquid, resulting in a problem of, for example, an increase in viscosity or occurrence of gelation during the storage of the coating liquid.

Problems with the polycarbonate described in Patent Literature 4 are that the CTM is degraded when irradiated with the electron beam and the residual potential is increased in use as the photoreceptor.

There are also examples where cross-linked polycarbonates and cross-linked polyarylates are obtainable without containing radical initiators or reaction catalysts which may cause deterioration of electrical properties and without using UV, electron beams, or the like which may degrade the CTM as described above.

As such an example, Patent Literature 5 reports a technique of using a monomer that has high radical polymerization activity and that is subjected to radical polymerization simply by heating without using an initiator or without irradiation with UV, and causing a polycarbonate having an allyl group to coexist with the monomer. However, it is considered that the use of the monomer that is subjected to radical polymerization without an initiator or light irradiation mainly produces a homopolymer of the polymerizable monomer and lowers the reaction probability between the polymerizable monomer and the polycarbonate having an allyl group with relatively low radical polymerization activity. Therefore, the resulting composition does not have a dense three-dimensional mesh-like structure of a polymer but is a composition in which a cross-linked polymer including the polycarbonate resin and the radical polymerizable monomer is separately present, and only portions thereof are bound together. The effect of improving physical properties due to the increase in the molecular weight of the charge transporting material, which is normally present as a low-molecular weight material, is dominant, and an improvement in the physical properties due to cross-linking of the polycarbonate moiety is insufficient. Further, since the highly active compound that is subjected to radical polymerization even without an initiator is used, it is difficult to inhibit the progress of polymerization at the stage of a coating liquid composition, resulting in a problem of, for example, an increase in viscosity or occurrence of gelation during the storage of the coating liquid.

Regarding a cross-linking technique that can satisfy these requirements, Patent Literature 6 discloses, as an example using a resin other than polycarbonate, a straight-chain polymer produced by molecular-weight extension reaction of an aliphatic-aromatic polyester by Diels-Alder reaction. The object of the invention described in Patent Literature 6, however, is to provide a technique with the following feature: the occurrence of retro-Diels-Alder reaction in which a bond formed by Diels-Alder reaction is dissociated at high temperature is used, and at high temperature, thermal moldability is improved by a decrease in melt viscosity due to a decrease in viscosity, and in an practical temperature region, mechanical physical properties are improved by an increase in the molecular weight, and solubility is maintained because the polymer has a straight-chain structure. This object is different from that of the invention, which aims to impart functions to a resin by introducing a reactive group and causing a reaction with a component having a group reactive with the reactive group. Further, Patent Literature 6 neither describes nor suggests the application of the technique described in Patent Literature 6 to an aromatic polycarbonate or a wholly aromatic polyester.

Patent Literature 7 describes examples where an aliphatic polyester, polyamide, or polyurea is cross-linked by Diels-Alder reaction. An object of these examples, however, is to provide solvent resistance and to obtain an elastomer applicable to a diaphragm seal or an adhesive, which is an intended use, by cross-linking a soft aliphatic resin. The technical idea of these examples differs from that of the invention, which aims to cause an aromatic polycarbonate or wholly aromatic polyester with high mechanical strength to have further enhanced functions through its reaction with a modifying component. Further, Patent Literature 7 neither describes nor suggests the application of the technique described in Patent Literature 7 to an aromatic polycarbonate or a wholly aromatic polyester.

Non-Patent Literature 1 describes an example where an anthracenedicarboxylic acid skeleton is introduced into polyethylene terephthalate (PET), and the resin is cross-linked with a bifunctional maleimide compound. The object of this example is similar to that of the invention in that mechanical physical properties are improved by thermal cross-linking; however, Non-Patent Literature 1 neither describes nor suggests that the technique described in Non-Patent Literature 1 is applied to a polycarbonate or a polyarylate. In addition, considering the application to an electrophotographic photoreceptor, PET cannot be used for this application because PET has low solubility in an organic solvent such as THF, which is typically used as a coating solvent, and has poor compatibility with a charge transporting material such as a triarylamine.

Moreover, there was not previously known a resin having a structure represented by a formula (FR1) described below.

It is an object of the invention to provide a resin that is capable of being subjected to a polymer reaction and that has a furan structure serving as a reactive group.

### Means for Solving the Problem(s)

According to an aspect of the invention, there is provided a resin having a repeating unit of a specific furan structure.

According to another aspect of the invention, there is provided a resin composition containing the resin according to the aspect of the invention.

According to still another aspect of the invention, there is provided a coating liquid composition containing the resin composition according to the another aspect of the invention and an organic solvent.

According to a further aspect of the invention, there is provided an electrophotographic photoreceptor including a layer that contains the resin according to the aspect of the invention.

According to a still further aspect of the invention, there is provided a molded product containing the resin according to the aspect of the invention.

According to a still further aspect of the invention, there is provided a film containing the resin according to the aspect of the invention.

According to a still further aspect of the invention, there is provided a coating film containing the resin according to the aspect of the invention.

According to a still further aspect of the invention, there is provided an insulative material containing the resin according to the aspect of the invention.

According to a still further aspect of the invention, there is provided an electronic device containing the resin according to the aspect of the invention.

According to a still further aspect of the invention, there is provided a method of producing a resin including heating the resin composition according to the another aspect of the invention to conduct a polymer reaction of the resin composition.

According to a still further aspect of the invention, there can be provided a resin that is capable of being subjected to a polymer reaction and that has a furan structure serving as a reactive group.

### BRIEF EXPLANATION OF DRAWINGS

FIG. 1 is a ¹H-NMR spectrum chart of PC-1, a raw material resin obtained in Example.

FIG. 2 is a ¹H-NMR spectrum chart of a polymer reactive composition obtained using PC-1, the raw material resin obtained in Example.

FIG. 3 is a ¹H-NMR spectrum chart of PC-2, a raw material resin obtained in Example.

FIG. 4 is a ¹H-NMR spectrum chart of a polymer reactive composition obtained using PC-2, the raw material resin obtained in Example.

FIG. 5 is a graph illustrating a relationship between light irradiation energy and surface potential of a multi-layer photoreceptor obtained in Example.

### DESCRIPTION OF EMBODIMENT(S)

### Resin

A resin according to the exemplary embodiment has a repeating unit of a structure represented by a formula (FR1) described below. Herein, this resin is occasionally referred to as a resin (or polymer) having a specific furan structure.

The resin according to the exemplary embodiment is preferably at least one resin selected from the group consisting of an aromatic polycarbonate and a polyarylate. Specific examples thereof include an aromatic polycarbonate, a polyarylate, and an aromatic polycarbonate-polyarylate copolymer (hereafter, these may be also referred to simply as “PCs”).

The resin according to the exemplary embodiment exhibits properties of being subjected to a polymer reaction due to Diels-Alder reaction. When the polymer reaction occurs, the furan structure serves as a reactive group in the structure represented by the formula (FR1) described below. A resin obtained by subjecting the resin having the repeating unit of the structure represented by the formula (FR1) to the polymer reaction has a structure represented by a formula (S1) below. In the formula (S1) below, * each represent a bonding position. Herein, various structures are bondable to the bonding positions represented by *.

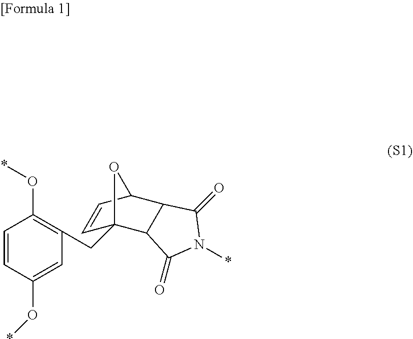

The resin according to the exemplary embodiment, by being subjected to the polymer reaction due to Diels-Alder reaction, is applicable to various purposes (cross-linking, grafting, polymer brush, carrying functional components, molecular chain extension, synthesis of a block copolymer of different kinds of polymers, and the like). A structure of a moiety obtained through the polymer reaction is, for example, a bonding form represented by a formula (P1) below.

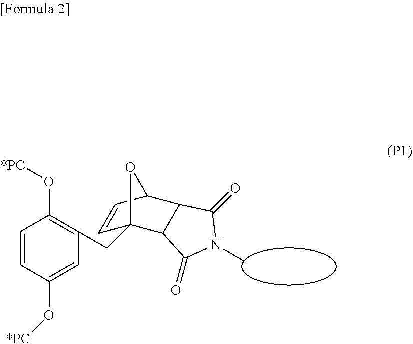

In the formula (P1), *PC each represent a polymer chain of PCs. An elliptical portion represents cross-linking, grafting, resin brush, carrying of a functional component, molecular weight extension, and the like. The elliptical portion in the formula (P1) may be any of cross-linking, grafting, resin brush, carrying of a functional component, molecular weight extension, synthesis of a block copolymer with different kinds of polymers, and the like, and is selectable therefrom as appropriate according to the purpose.

As a result of diligent studies to solve the problems of the invention described above, the inventors have found out a novel resin that exhibits properties of being subjected to a polymer reaction with a substance having a dienophile structure with no need to contain a radical initiator, a reaction catalyst, or the like and no need to use an ultraviolet ray, an electron beam, or the like. The invention has been completed based on the above finding.

The resin according to the exemplary embodiment has the repeating unit of the structure represented by the formula (FR1). The resin according to the exemplary embodiment is a polymer having a specific furan structure with Diels-Alder reactivity.

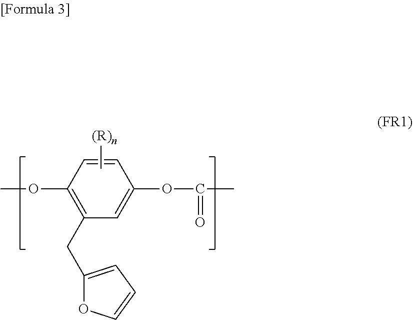

In the formula (FR1):
R are each independently an aliphatic hydrocarbon group having 1 to 6 carbon atoms, an aromatic hydrocarbon group having 6 to 12 ring carbon atoms, an alkoxy group having 1 to 10 carbon atoms, or a halogen atom;
a plurality of R are optionally linked together to form a cyclic structure (including an aromatic ring and a heterocycle);
when a plurality of R are present, the plurality of R may be the same or different; and
n represents an integer in a range from 0 to 3.

In the formula (FR1), examples of the aliphatic hydrocarbon group having 1 to 6 carbon atoms and denoted by R include saturated or unsaturated aliphatic hydrocarbon groups (an alkyl group, an alkenyl group, and an alkynyl group). Examples of the alkyl group as the aliphatic hydrocarbon group having 1 to 6 carbon atoms include a methyl group, an ethyl group, a n-propyl group, a n-butyl group, a n-pentyl group, a n-hexyl group, an isopropyl group, an isobutyl group, a sec-butyl group, a tert-butyl group, an isopentyl group, a neopentyl group, a tert-pentyl group, an isohexyl group, a sec-hexyl group, and a tert-hexyl group. Examples of the alkenyl group as the aliphatic hydrocarbon group having 1 to 6 carbon atoms include a vinyl group (ethenyl group), a 1-propenyl group, a 2-propenyl group, a 2-butenyl group, a 1-butenyl group, and a 1-hexenyl group. Examples of the alkynyl group as the aliphatic hydrocarbon group having 1 to 6 carbon atoms include an ethynyl group, a 1-propynyl group, a 2-propynyl group, a 1-butynyl group, and a 3-hexynyl group.

In the formula (FR1), examples of the aromatic hydrocarbon group having 6 to 12 ring carbon atoms and denoted by R include a phenyl group, a naphthyl group, and a biphenyl group.

In the formula (FR1), examples of the alkoxy group having 1 to 10 carbon atoms and denoted by R include a methoxy group, an ethoxy group, a n-propoxy group, a n-butoxy group, a n-pentyloxy group, a n-hexyloxy group, a n-heptyloxy group, a n-octyloxy group, a n-nonyloxy group, a n-decyloxy group, an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

In the formula (FR1), examples of the halogen atom denoted by R include a fluorine atom, a chlorine atom, a bromine atom, and an iodine atom.

In the resin according to the exemplary embodiment, the repeating unit of the structure represented by the formula (FR1) preferably has a molar composition ratio in a range from 0.1 mol % to 100 mol % with respect to a total of repeating units.

The repeating unit of the structure represented by the formula (FR1) preferably has a molar composition ratio of 0.1 mol % or more, more preferably 1 mol % or more, and still more preferably 10 mol % or more, with respect to a total of repeating units, from the viewpoint of obtaining a property improvement effect resulting from the introduction of the modifying component.

The repeating unit of the structure represented by the formula (FR1) preferably has a molar composition ratio of 100 mol % or less, more preferably 70 mol % or less, and still more preferably 50 mol % or less, with respect to a total of repeating units, from the viewpoint of allowing for setting the modifying structure to be introduced as desired.

Any structure that causes Diels-Alder reaction can be applied to the dienophile structure that causes the resin having the repeating unit of the structure represented by the formula (FR1) to be subjected to the polymer reaction. A substance having a maleimide skeleton is suitably used as a substance with the dienophile structure in view of their high reactivity.

Examples of the dienophile structure include bismaleimides such as 4,4′-diphenylmethane bismaleimide, m-phenylene bismaleimide, bisphenol A diphenyl ether bismaleimide, 3,3′-dimethyl-5,5′-diethyl-4,4′-diphenylmethane bismaleimide, 4-methyl-1,3-phenylene bismaleimide, 1,6′-bismaleimide-(2,2,4-trimethyl)hexane, 4′-diphenyl ether bismaleimide, 4,4′-diphenylsulfone bismaleimide, 1,3-bis(3-maleimidophenoxy)benzene, 1,3-bis(4-maleimidophenoxy)benzene, a diphenylmethane-4,4′-bismaleimide polymer having 4,4′-methylenedianiline, N,N′-(2,2′-diethyl-6,6′-dimethylenediphenylene)bismaleimide, N,N′-(4-methyl-m-phenylene)bismaleimide, N,N′-m-phenylene dimaleimide, N,N′-m-phenylene bismaleimide, and polyphenylmethane bismaleimide; monomaleimides such as N-phenylmaleimide; and PCs having a structure in which a molecular terminal is terminated with a compound below.

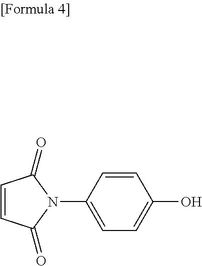 [SMILES: O=C1C=CC(=O)N1c1ccc(O)cc1]

In the exemplary embodiment, the dienophile structure or dienophile group (hereafter, may also be simply referred to as “dienophile”) preferably includes a structure represented by a formula (DP1) below.

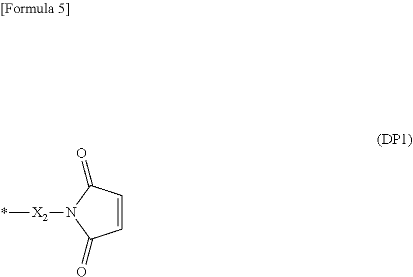

In the formula (DP1):
X₂ is a single bond or a linking group to another skeleton;
X₂ serving as the linking group is a group which contains at least one atom selected from the group consisting of a carbon atom, an oxygen atom, a nitrogen atom, a sulfur atom, a silicon atom, a phosphorus atom, and a boron atom and in which bonding forms between atoms constituting the linking group are each a covalent bond.
* represents a bonding position.

In the exemplary embodiment, the dienophile structure or the dienophile group particularly preferably includes a structure represented by a formula (DP2) below. In the formula (DP2) below, * represents a bonding position.

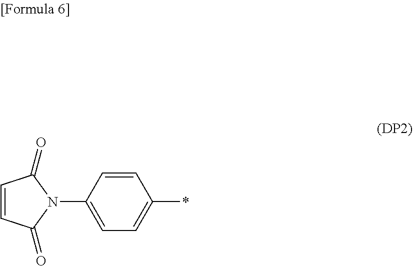 [SMILES: *c1ccc(N2C(=O)C=CC2=O)cc1]

In imparting functions through the polymer reaction in the exemplary embodiment, a ratio of the furan to the dienophile may be set as appropriate according to the target physical property and intended use. A molar ratio of the furan to the dienophile (furan/dienophile) is preferably in a range from 0.01 to 100, more preferably in a range from 0.1 to 10, still more preferably in a range from 0.2 to 5, and still further more preferably in a range from 0.5 to 1.5. When the molar ratio of the furan to the dienophile is less than 0.01 or more than 100, the modification effect may be insufficiently obtained.

The resin according to the exemplary embodiment preferably includes at least one of a structure represented by a formula (UN1) below or a structure represented by a formula (UN2) below.

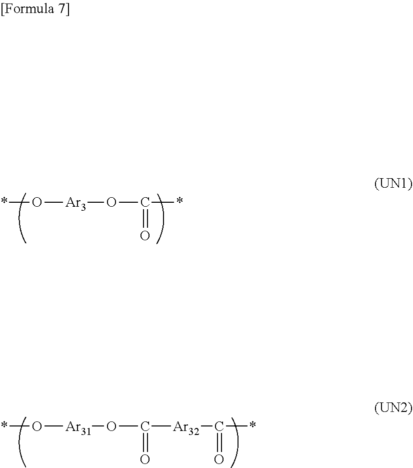

In the formula (UN1) and the formula (UN2), Ar₃, Ar₃₁ and Ar₃₂ are each independently a group represented by a formula (UN11) below.
* each represent a bonding position.

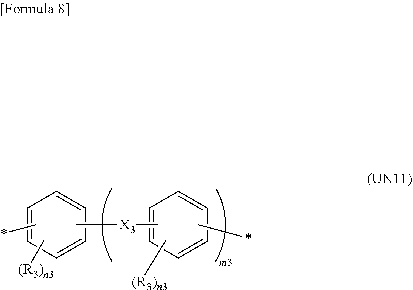

In the formula (UN11):
m3 is 0, 1 or 2;
n3 is 4;
a plurality of R₃ are each independently a hydrogen atom, a halogen atom, an alkyl having 1 to 10 carbon atoms, an aryl having 6 to 12 ring carbon atoms, or a fluorinated alkyl having 1 to 10 carbon atoms;
a plurality of R₃ may be the same or different;
X₃ are each independently a group constituted by one or two or more selected from the group consisting of a single bond, —C(—R₃₁)₂—, —O—, —S—, —SO—, —SO₂— —N(—R₃₂)—, —P(—R₃₃)—, —P═O(—R₃₄)—, a carbonyl, an ester, an amide, an alkylene having 2 to 20 carbon atoms, an alkylidene having 2 to 20 carbon atoms, a cycloalkylene having 3 to 20 ring carbon atoms, a cycloalkylidene having 3 to 20 ring carbon atoms, an arylene having 6 to 20 ring carbon atoms, a bicycloalkanediyl having 4 to 20 ring carbon atoms, a tricycloalkanediyl having 5 to 20 ring carbon atoms, a bicycloalkylidene having 4 to 20 ring carbon atoms, and a tricycloalkylidene having 5 to 20 ring carbon atoms; and
R₃₁ to R₃₄ are each independently a hydrogen atom, a halogen atom, an alkyl having 1 to 10 carbon atoms, an aryl having 6 to 12 ring carbon atoms, or a fluorinated alkyl having 1 to 10 carbon atoms.
* each represent a bonding position.

In the formula (UN11), examples of the halogen atom denoted by R₃ include a fluorine atom, a chlorine atom, a bromine atom, and an iodine atom.

In the formula (UN11), examples of the alkyl having 1 to 10 carbon atoms and denoted by R₃ include methyl, ethyl, n-propyl, n-butyl, n-pentyl, n-hexyl, n-heptyl, n-octyl, n-nonyl, n-decyl, isopropyl, isobutyl, sec-butyl, tert-butyl, isopentyl, neopentyl, tert-pentyl, isohexyl, sec-hexyl, tert-hexyl, isoheptyl, sec-heptyl, tert-heptyl, isooctyl, sec-octyl, tert-octyl, isononyl, sec-nonyl, tert-nonyl, isodecyl, sec-decyl, and tert-decyl groups.

In the formula (UN11), examples of the aryl having 6 to 12 ring carbon atoms and denoted by R₃ include phenyl, naphthyl, and biphenyl groups.

In the formula (UN11), examples of the fluorinated alkyl having 1 to 10 carbon atoms and denoted by R₃ include groups of alkyl mentioned as examples of the alkyl having 1 to 10 carbon atoms and denoted by R₃ in the formula (UN11), in which at least one hydrogen atom bonded to a carbon atom is substituted with a fluorine atom.

In the formula (UN11), the alkylene having 2 to 20 carbon atoms and denoted by X₃ may be a linear or branched alkylene group, and examples thereof include ethylene, propylene, isopropylene, butylene, hexylene, octylene, and decylene groups.

In the formula (UN11), examples of the alkylidene having 2 to 20 carbon atoms and denoted by X₃ include ethylidene, propylidene, butylidene, hexylidene, octylidene, decylidene, pentadecylidene, and icosylidene groups.

In the formula (UN11), examples of the cycloalkylene having 3 to 20 carbon atoms and denoted by X₃ include cyclopropylene, cyclobutylene, cyclohexylene, cyclooctylene, cyclodecylene, cyclododecylene, cyclopentadecylene, and cycloicosylene groups.

In the formula (UN11), examples of the cycloalkylidene having 3 to 20 carbon atoms and denoted by X₃ include cyclobutylidene, cyclopentylidene, cyclohexylidene, cyclooctylidene, cyclodecylidene, cyclododecylidene, cyclopentadecylidene, and cycloicosylidene groups.

In the formula (UN11), examples of the arylene having 6 to 20 ring carbon atoms and denoted by X₃ include phenylene, naphthylene, and biphenylene groups.

In the formula (UN11), examples of the bicycloalkanediyl having 4 to 20 ring carbon atoms and denoted by X₃ include bicyclic products of the cycloalkylene mentioned above, and examples of the tricycloalkanediyl having 5 to 20 ring carbon atoms include tricyclic products of the cycloalkylene mentioned above. Examples thereof include groups such as adamantanediyl and tricyclodecanediyl.

In the formula (UN11), examples of the bicycloalkylidene having 4 to 20 ring carbon atoms and denoted by X₃ include bicyclic products of the cycloalkylidene mentioned above, and examples of the tricycloalkylidene having 5 to 20 ring carbon atoms include tricyclic products of the cycloalkylidene mentioned above. Examples thereof include groups such as adamantylidene and tricyclodecylidene.

In the formula (UN11), examples of the halogen atom, the alkyl having 1 to 10 carbon atoms, the aryl having 6 to 12 ring carbon atoms, and the fluorinated alkyl having 1 to 10 carbon atoms, the halogen atom, alkyl, aryl, and fluorinated alkyl being denoted by R₃₁ to R₃₄ of X₃, include the same groups as the groups denoted by R₃ in the formula (UN11).

### Method of Producing Resin Obtained Through Polymer Reaction

A method of producing the resin obtained through the polymer reaction according to the exemplary embodiment includes heating a resin composition according to the exemplary embodiment described below to conduct the polymer reaction of the resin composition. Exemplary components of the resin composition to conduct the polymer reaction include components (i), (ii) and (iii) in the later-described resin composition according to the exemplary embodiment. A heating temperature to conduct the polymer reaction of the resin composition may depend on the target property, use, and the like. The heating temperature to conduct the polymer reaction is, for example, in a range from 60 degrees C. to 250 degrees C. The method of producing the resin obtained through the polymer reaction may include applying a coating liquid composition described below to a target by wet molding, removing an organic solvent in the coating liquid composition by heating, and conducting the polymer reaction of the resin composition in the coating liquid composition by heating simultaneously with the heating in the removal of the organic solvent or by continuously heating. The method of producing the resin obtained through the polymer reaction may be a method in which a resin is modified through the polymer reaction in advance and the resultant modified resin is used to give a molded product.

Among the above components, a polymer having two or more structures represented by the formula (FR1) in a polymer chain (a polycarbonate polymer, specifically an aromatic polycarbonate) will be described in detail with reference to examples.

A first arrangement of the polycarbonate polymer (hereinafter, also referred to as a PC polymer) according to the exemplary embodiment has at least a repeating unit selected from a repeating unit A represented by a formula (1) below and a repeating unit B represented by a formula (2) below, and is obtained by using, as a raw material, at least one of a bischloroformate oligomer represented by a formula (1A) below, a bischloroformate oligomer represented by a formula (2A) below, or a bischloroformate oligomer represented by a formula (2C) below.

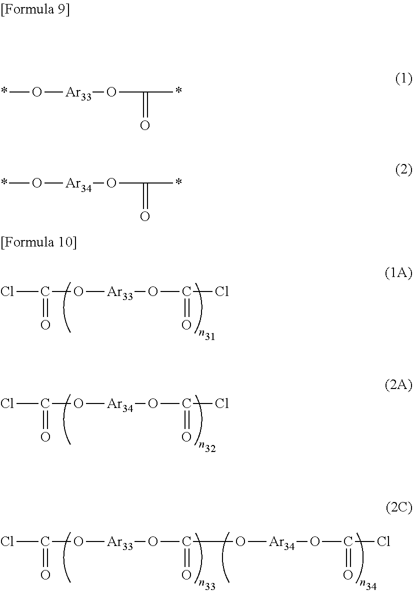

In the formulae (1) and (1A), Ar33 is a divalent benzene ring residue in a group represented by the formula (FR1), and n31 represents an average number of repeating units. The average number of repeating units n31 is in a range from 1.0 to 10.

In the formulae (2) and (2A), Ar₃₄ is a group represented by the formula (UN11), and n₃₂ represents an average number of repeating units. The average number of repeating units n₃₂ is in a range from 1.0 to 10.

In the formula (2C), Ar₃₃ is a divalent benzene ring residue in a group represented by the formula (FR1), and Ar₃₄ is a group represented by the formula (UN11). n₃₃ and n₃₄ each represent an average number of repeating units. The total of the average numbers of repeating units n₃₃ and n₃₄ is in a range from 1.0 to 10.

In the formulae (1) and (2), * each represent a bonding position.

Ar₃₃ and Ar₃₄ are mutually different. In the formula (2C), the respective repeating units do not necessarily have to be successive.

The method for calculating the average number of repeating units may be a method described in Examples below.

The divalent benzene ring residue in a group represented by formula (FR1) is represented by a formula (FR1A) below. In the formula (FR1A), R and n in a group represented by (R)n are the same as R and n in a group represented by (R)n in the formula (FR1).

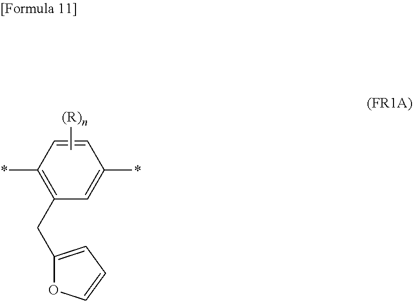

Such a PC polymer has the repeating unit A that includes, for example, a group represented by the formula (FR1) having a specific furan structure, and thus is a polymer having two or more conjugated diene structures in a polymer chain.

A PC polymer having a repeating unit constituted by the repeating unit A represented by the formula (1) alone and a PC polymer having the repeating unit A represented by the formula (1) and the repeating unit B represented by the formula (2) are each preferably a polymer represented by a formula (100) below. That is, the PC polymer is preferably an aromatic polycarbonate having a repeating unit constituted by the repeating unit A represented by the formula (1) alone or an aromatic polycarbonate having the repeating unit A represented by the formula (1) and the repeating unit B represented by the formula (2) and is preferably a polymer represented by the formula (100) below. In the formula (1), Ar₃₃ is a divalent benzene ring residue in a group represented by the formula (FR1), and in the formula (2), Ar₃₄ is a group represented by the formula (UN11).

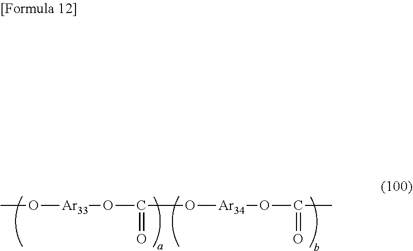

In the formula (100), a represents a molar copolymerization ratio in the repeating unit A, and b represents a molar copolymerization ratio in the repeating unit B.

a is [Ar₃₃]/([Ar₃₃]+[Ar₃₄]), b is [Ar₃₄]/([Ar₃₃]+[Ar₃₄]), and the case where b is 0 is also included. [Ar₃₃] represents the number of moles of the repeating unit A that includes a group represented by Ar₃₃ in the PC polymer, and [Ar₃₄] represents the number of moles of the repeating unit B that includes a group represented by Ar₃₄ in the PC polymer.

In the formula (100), the respective repeating units are not necessarily successive.

The PC polymer represented by the formula (100) may be any copolymer such as a block copolymer, an alternating copolymer, or a random copolymer.

A chain terminal of the PC polymer according to the exemplary embodiment is preferably terminated with, besides any of the above specific terminal groups, a monovalent aromatic group or a monovalent fluorine-containing aliphatic group as long as the requirements of the present application are satisfied.

The monovalent aromatic group may be a group containing an aliphatic group.

The monovalent fluorine-containing aliphatic group may be a group containing an aromatic group.

At least one substituent selected from the group consisting of alkyl groups, halogen atoms, and aryl groups may be added to the monovalent aromatic group and the monovalent fluorine-containing aliphatic group. At least one substituent selected from the group consisting of alkyl groups, halogen atoms, and aryl groups may be further added to these substituents. When a plurality of substituents are present, these substituents may be bonded together to form a ring.

The monovalent aromatic group constituting a chain terminal preferably includes an aryl group having 6 to 12 ring carbon atoms. Examples of the aryl group include a phenyl group and a biphenyl group.

Examples of the substituent added to the aromatic group and the substituent added to an alkyl group added to the aromatic group include halogen atoms such as a fluorine atom, a chlorine atom, and a bromine atom. Examples of the substituent added to the aromatic group include alkyl groups having 1 to 20 carbon atoms. These alkyl groups may each be a group to which a halogen atom is added as described above or a group to which an aryl group is added.

The monovalent fluorine-containing aliphatic group constituting a chain terminal may be a monovalent group derived from a fluorine-containing alcohol.

The fluorine-containing alcohol is preferably an alcohol in which a plurality of fluoroalkyl chains having 2 to 6 carbon atoms are linked together with an ether bond therebetween and which has 13 to 19 fluorine atoms in total. When the total number of fluorine atoms is 13 or more, sufficient water repellency and oil repellency can be exhibited. On the other hand, when the total number of fluorine atoms is 19 or less, a decrease in reactivity during polymerization is restrained, and at least one of mechanical strength, surface hardness, heat resistance, or the like of the resulting PC polymer can be improved.

Further, the monovalent fluorine-containing aliphatic group is also preferably a monovalent group derived from a fluorine-containing alcohol having two or more ether bonds. The use of such a fluorine-containing alcohol enhances dispersibility of the PC polymer in a coating liquid composition, improves abrasion resistance in a molded body or an electrophotographic photoreceptor, and can maintain surface lubricating properties, water repellency, and oil repellency after abrasion.

Alternatively, the fluorine-containing alcohol is also preferably a fluorine-containing alcohol represented by a formula (30) or (31) below, a fluorine-containing alcohol such as 1,1,1,3,3,3-hexafluoro-2-propanol, or a fluorine-containing alcohol having an ether bond and represented by a formula (32), (33), or (34) below.

H(CF₂)ₙ₁CH₂OH (30)

F(CF₂)ₘ₁CH₂OH (31)

In the formula (30), n1 is an integer of 1 to 12, and in the formula (31), m1 is an integer of 1 to 12.

F—(CF₂)ₙ³¹—OCF₂CH₂—OH (32)

F—(CF₂CF₂)ₙ³²—(CF₂CF₂O)ₙ³³—CF₂CH₂OH (33)

CR₃—(CF₂)ₙ³⁵—O—(CF₂CF₂O)ₙ³⁴—CF₂CH₂OH (34)

In the formula (32), n³¹ is an integer of 1 to 10, preferably an integer of 5 to 8.

In the formula (33), n³² is an integer of 0 to 5, preferably an integer of 0 to 3. n³³ is an integer of 1 to 5, preferably an integer of 1 to 3.

In the formula (34), n³⁴ is an integer of 1 to 5, preferably an integer of 1 to 3. n³⁵ is an integer of 0 to 5, preferably an integer of 0 to 3. R is CF₃ or F.

In the exemplary embodiment, from the viewpoint of improving electrical characteristics and abrasion resistance, a chain terminal of the PC polymer is preferably terminated with a monovalent group derived from a phenol represented by a formula (35) below or a monovalent group derived from a fluorine-containing alcohol represented by a formula (36) below.

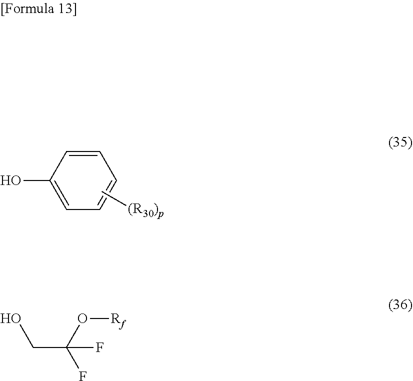

In the formula (35), R₃₀ represents an alkyl group having 1 to 10 carbon atoms or a fluoroalkyl group having 1 to 10 carbon atoms, and p is an integer of 1 to 3.

In the formula (36), R_{f} represents a perfluoroalkyl group having 5 or more carbon atoms and 11 or more fluorine atoms, or a perfluoroalkyloxy group represented by a formula (37) below.

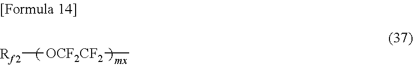

In the formula (37), R_{f2} is a linear or branched perfluoroalkyl group having 1 to 6 carbon atoms. mx is an integer of 1 to 3.

One example of the method of producing the PC polymer according to the exemplary embodiment is a production method in which at least one of a bischloroformate oligomer compound represented by the formula (1A) or a bischloroformate oligomer compound represented by the formula (2A), an organic solvent, an alkaline aqueous solution, and a monomer such as a bisphenol compound are used, and an organic layer and an aqueous layer are mixed to conduct interfacial polycondensation reaction.

In the method of producing the PC polymer according to the exemplary embodiment, a monovalent carboxylic acid and a derivative thereof, a monovalent phenol, and the like can be used as a terminal terminator for generating a chain terminal.

For example, p-tert-butyl-phenol, p-phenylphenol, p-cumylphenol, p-perfluorononylphenol, p-(perfluorononylphenyl)phenol, p-(perfluorohexyl)phenol, p-tert-perfluorobutylphenol, p-perfluorooctylphenol, 1-(p-hydroxybenzyl)perfluorodecane, p-[2-(1H, 1H-perfluorotridodecyloxy)-1,1,1,3,3,3-hexafluoropropyl]phenol, 3,5-bis(perfluorohexyloxycarbonyl)phenol, perfluorododecyl p-hydroxybenzoate, p-(1H,1H-perfluorooctyloxy)phenol, 2H,2H,9H-perfluorononanoic acid, and the like are suitably used.

Alternatively, a fluorine-containing alcohol represented by the formula (30) or (31) or a monovalent fluorine-containing alcohol such as 1,1,1,3,3,3-hexafluoro-2-propanol is also suitably used as the terminal terminator for generating a chain terminal. It is also preferable to use a fluorine-containing alcohol having an ether bond and represented by the formula (32), (33), or (34) as the terminal terminator for generating a chain terminal.

Of these, a monovalent phenol represented by the formula (35) or a monovalent fluorine-containing alcohol represented by the formula (36) is preferably used as the terminal terminator for generating a chain terminal from the viewpoint of improving electrical characteristics and abrasion resistance.

As the monovalent phenol represented by the formula (35), for example, p-tert-butyl-phenol, p-perfluorononylphenol, p-perfluorohexylphenol, p-tert-perfluorobutylphenol, or p-perfluorooctylphenol is suitably used. That is, in the exemplary embodiment, a chain terminal is preferably terminated with a terminal terminator selected from the group consisting of p-tert-butyl-phenol, p-perfluorononylphenol, p-perfluorohexylphenol, p-tert-perfluorobutylphenol, and p- perfluorooctylphenol.

Examples of the fluorine-containing alcohol having an ether bond and represented by the formula (36) include compounds below. That is, it is also preferable that the chain terminal according to the exemplary embodiment be terminated with a terminal terminator selected from the following fluorine-containing alcohols.

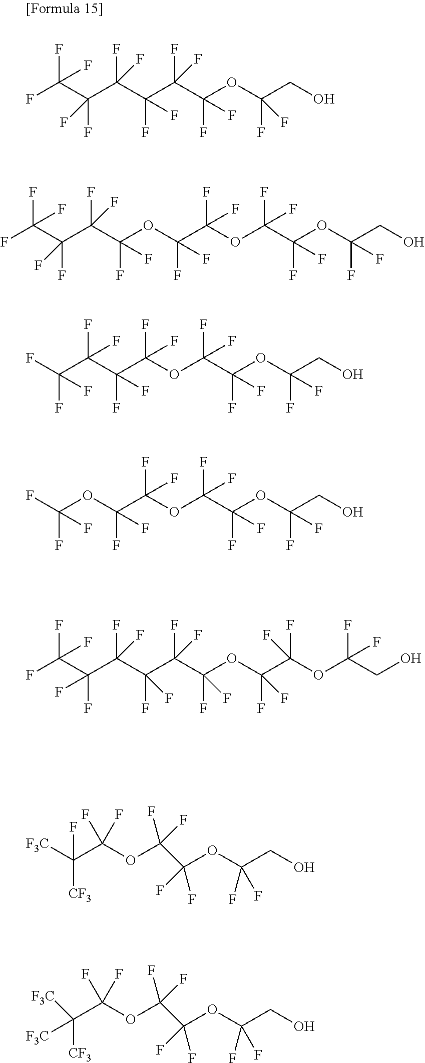

Regarding the proportion of the terminal terminator added, an appropriate proportion is different between the case where a Diels-Alder reactive functional group (conjugated diene or dienophile) is located at a terminal and the case where such a reactive functional group is located in the main chain or a side chain. In the case where a conjugated diene or a dienophile is included at a terminal, the concentration of a cross-linkable reactive group and the molecular weight change along with the fraction of the terminal. The proportion is preferably in a range from 0.1 mol % to 67 mol %, more preferably in a range from 0.5 mol % to 50 mol % in terms of mole percentage of the copolymer composition of diene or dienophile terminal groups relative to the total of repeating units of the main chain and terminals. When the proportion of the terminal terminator added is 67 mol % or less, a decrease in the mechanical strength can be inhibited. When the proportion is 0.1 mol % or more, the effect of improving characteristics due to cross-linking can be obtained. In the case where a conjugated diene or a dienophile is not included, the proportion is preferably in a range from 0.05 mol % to 40 mol %, more preferably in a range from 0.1 mol % to 20 mol % in terms of mole percentage of the copolymer composition of chain terminals relative to the total of repeating units of the main chain and terminals. When the proportion of the terminal terminator added is 40 mol % or less, a decrease in the mechanical strength can be inhibited. When the proportion is 0.05 mol % or more, deterioration of moldability can be inhibited.

No particular limitation is imposed on a branching agent that can be used in the method of producing the PC polymer according to the exemplary embodiment, and specific examples of the branching agent include phloroglucin, pyrogallol, 4,6-dimethyl-2,4,6-tris(4-hydroxyphenyl)-2-heptene, 2,6-dimethyl-2,4,6-tris(4-hydroxypheny)-3-heptene, 2,4-dimethyl-2,4,6-tris(4-hydroxyphenyl)heptane, 1,3,5-tris(2-hydroxyphenyl)benzene, 1,3,5-tris(4-hydroxyphenyl)benzene, 1,1,1-tris(4-hydroxyphenyl)ethane, tris(4-hydroxyphenyl)phenylmethane, 2,2-bis[4,4-bis(4-hydroxyphenyl) cyclohexyl]propane, 2,4-bis[2-bis(4-hydroxyphenyl)-2-propyl]phenol, 2,6-bis(2-hydroxy-5-methylbenzyl)-4-methylphenol, 2-(4-hydroxyphenyl)-2-(2,4-dihydroxyphenyl)propane, tetrakis(4-hydroxyphenyl)methane, tetrakis [4-(4-hydroxyphenylisopropyl)phenoxy]methane, 2,4-dihydroxybenzoic acid, trimesic acid, cyanuric acid, 3,3-bis(3-methyl-4-hydroxyphenyl)-2-oxo-2,3-dihydroindole, 3,3-bis(4-hydroxyaryl) oxyindole, 5-chloroisatin, 5,7-dichloroisatin, and 5-bromoisatin.

The proportion of the branching agent added is preferably 30 mol % or less, more preferably 5 mol % or less in terms of mole percentage of the copolymer composition of the repeating unit A, the repeating unit B, and chain terminals or in terms of mole percentage of the copolymer composition of the repeating unit A and chain terminals. When the proportion of the branching agent added is 30 mol % or less, deterioration of moldability can be inhibited.

In the case of conducting interfacial polycondensation, examples of an acid-binding agent include alkali metal hydroxides such as sodium hydroxide, potassium hydroxide, lithium hydroxide, and cesium hydroxide; alkaline earth metal hydroxides such as magnesium hydroxide and calcium hydroxide; alkali metal weak acid salts and alkaline earth metal weak acid salts such as sodium carbonate, potassium carbonate, and calcium acetate; and organic bases such as pyridine. Preferred acid-binding agents used in the case of conducting interfacial polycondensation are alkali metal hydroxides and alkaline earth metal hydroxides such as sodium hydroxide, potassium hydroxide, and calcium hydroxide. These acid-binding agents may be used as a mixture. The proportion of the acid-binding agent used may be also appropriately adjusted in consideration of the stoichiometric ratio (equivalent) of the reaction. Specifically, the acid-binding agent may be used in an amount of 1 equivalent or in a more excessive amount per 1 mole of the total of hydroxy groups of a divalent phenol serving as a raw material. Preferably, 1 to 10 equivalents of the acid-binding agent may be used.

A solvent used in the method of producing the PC polymer according to the exemplary embodiment is simply required to exhibit solubility to the obtained copolymer at a predetermined level or more. Preferred examples of the solvent include aromatic hydrocarbons such as toluene and xylene; halogenated hydrocarbons such as methylene chloride, chloroform, 1,1-dichloroethane, 1,2-dichloroethane, 1,1,1-trichloroethane, 1,1,2-trichloroethane, 1,1,1,2-tetrachloroethane, 1,1,2,2-tetrachloroethane, pentachloroethane, and chlorobenzene; ketones such as cyclohexanone, acetone, and acetophenone; and ethers such as tetrahydrofuran and 1,4-dioxane. These solvents may be used alone or in combination of two or more thereof. Further, the interfacial polycondensation reaction may be conducted using two solvents that are immiscible with each other.

It is preferable to use, as the organic solvent used in the method of producing the PC polymer according to the exemplary embodiment, an organic solvent that is substantially immiscible with water and that can dissolve the finally obtained polycarbonate copolymer in an amount of 5 mass % or more. The organic solvent is preferably an organic solvent that is substantially immiscible with water and that can dissolve the finally obtained polycarbonate copolymer in an amount of 5 mass % or more.

Herein, the organic solvent that is “substantially immiscible with water” refers to an organic solvent that does not provide a solution formed of a uniform layer (a solution in which neither a gelled product nor insoluble matter is observed) when water and the organic solvent are mixed in a composition range of 1:9 to 9:1.

The organic solvent “can dissolve the finally obtained polycarbonate copolymer in an amount of 5 mass % or more” means a solubility of the polycarbonate copolymer as measured at a temperature of 20 degrees C. to 30 degrees C. and normal pressure.

The “finally obtained polycarbonate polymer” refers to a polymer obtained through a polymerization step in the method of producing the polycarbonate polymer according to the exemplary embodiment, the polymer before being subjected to cross-linking.

Examples of such an organic solvent include aromatic hydrocarbons such as toluene, ketones such as cyclohexanone, and halogenated hydrocarbons such as methylene chloride. Of these, methylene chloride is preferred because of its high solubility.

No particular limitation is imposed on a catalyst used in the method of producing the PC polymer according to the exemplary embodiment, and preferred examples thereof include tertiary amines such as trimethylamine, triethylamine, tributylamine, N,N-dimethylcyclohexylamine, pyridine, N,N-diethylaniline, and N,N-dimethylaniline; quaternary ammonium salts such as trimethylbenzylammonium chloride, triethylbenzylammonium chloride, tributylbenzylammonium chloride, trioctylmethylammonium chloride, tetrabutylammonium chloride, and tetrabutylammonium bromide; and quaternary phosphonium salts such as tetrabutylphosphonium chloride and tetrabutylphosphonium bromide.

Further, a small amount of an antioxidant such as sodium sulfite or a hydrosulfite salt may be added as needed to the reaction system of the PC polymer of the exemplary embodiment.

The method of producing the resin according to the exemplary embodiment may include, for example, a polymerization step of polymerizing a resin by use of 2-(2-furanylmethyl)hydroquinone in the presence of an organic solvent and an alkaline aqueous solution. In the polymerization step, a bischloroformate oligomer compound or a terminal terminator may be further used. In the polymerization step, an oxygen concentration is preferably reduced. The alkaline aqueous solution in the polymerization step is preferably an alkaline aqueous solution containing a weak base. Further, the polymerization step may include mixing the alkaline aqueous solution with an organic layer that is obtained by containing 2-(2-furanylmethyl)hydroquinone in an organic solvent. The method of producing the resin according to the exemplary embodiment may include a washing step. The method of producing the PC polymer is exemplified by a method below.

In the method of producing the PC polymer according to the exemplary embodiment, since monomers easily undergo oxidization into a quinone structure, the concentration of oxygen in the reaction system is reduced during polymerization and, if necessary, during washing. The oxygen concentration is 1.0 mg/L or less, preferably 0.5 mg/L or less, more preferably 0.2 mg/L or less, still more preferably 0.1 mg/L or less, and still further more preferably 0.05 mg/L or less in terms of a value read using a DO meter (dissolved oxygen meter) described in Example. In the case where the oxygen concentration exceeds 1.0 mg/L, the polymerization step and the washing step may deteriorate due to the incorporation of impurities that are components degraded by coloring and oxidation owing to the formation of quinone, or oxygen may remain in a polymer to be finally obtained to cause an adverse effect in use. The oxygen concentration is preferably reduced in all of the reaction system, the organic solvent, and the aqueous solution. Using an oxygen-consuming type antioxidant such as sodium sulfite and a hydrosulfite salt for the aqueous solution is effective to lower an oxygen concentration value read on the DO meter.

Since the quinone structure is formed noticeably in conditions where alkali is strong and oxygen is present, it is also effective to use a weak base, such as potassium carbonate or sodium carbonate, in place of a strong base normally used, such as sodium hydroxide.

The formation of quinone can also be inhibited by reducing the frequency of contact with alkaline during polymerization. Specifically, a monomer is normally polymerized by being dissolved in an alkaline solution. By dissolving 2-(2-furanylmethyl)hydroquinone, which is a raw material of the polymer of the invention, in an organic solvent (dichloromethane, acetone, etc.), adding the mixture to an organic layer in the polymerization reaction, and then mixing the resultant with an alkaline aqueous solution for the reaction to proceed, 2-(2-furanylmethyl)hydroquinone is brought into contact with alkali only at the interface, with oxygen immediately consumed by the polymer extension reaction. The oxidation into quinone is thus effectively preventable.

### Resin Composition

The resin composition according to the exemplary embodiment contains the resin according to the exemplary embodiment described above. That is, the resin composition according to the exemplary embodiment contains the resin having a specific furan structure. The resin composition according to the exemplary embodiment contains the resin having at least the structure represented by the formula (FR1) and a compound having the dienophile structure or a resin having the dienophile structure. In the resin composition according to the exemplary embodiment, for example, the resin containing at least the structure represented by the formula (FR1) may be a polymer represented by the formula (100), and the compound containing the dienophile structure or the resin containing the dienophile structure may contain the structure represented by the formula (DP2).

The resin composition according to the exemplary embodiment may also be a composition that is subjected to the polymer reaction to give the resin according to the exemplary embodiment obtained through the polymer reaction.

That is, the resin composition according to the exemplary embodiment may contain, in combination, a polymer having a specific furan structure with Diels-Alder reactivity and a reactant having the dienophile group or dienophile structure. The resin composition according to the exemplary embodiment may contain a polymer having the dienophile structure and the specific furan structure with Diels-Alder reactivity. When the resin composition has a specific furan structure and the dienophile structure in one polymer, the dienophile structure in the molecule serves as a reactant having the dienophile structure.

The resin composition according to the exemplary embodiment may contain a resin obtained through the polymer reaction between a polymer having a specific furan structure and a reactant having the dienophile structure.

The furan, the dienophile, and a ratio of the furan to the dienophile in the resin composition according to the exemplary embodiment are the same as those in the resin according to the exemplary embodiment.

Concentrations of the furan and the dienophile in the resin composition according to the exemplary embodiment may be set as appropriate according to the target physical property and intended use. When the number of moles of the furan is defined as a functional group concentration relative to a total amount of the composition having a Diels-Alder reactive group, the functional group concentration is preferably in a range from 0.01 mmol/g to 10 mmol/g, more preferably in a range from 0.03 mmol/g to 7 mmol/g, still more preferably in a range from 0.1 mmol/g to 5 mmol/g, still further more preferably in a range from 0.3 mmol/g to 5 mmol/g, and yet still further more preferably in a range from 0.5 mmol/g to 2 mmol/g. When the functional group concentration is less than 0.01 mmol/g, the modification effect due to the polymer reaction may be insufficient. When the functional group concentration exceeds 10 mmol/g, a density of the furan structure is so high that unreacted functional groups are likely to remain. This may cause the polymer reaction and other side reactions to proceed over time, resulting in the change or deterioration of physical properties of materials. Such functional group concentration is thus not preferable.

Examples of components of the resin composition according to the exemplary embodiment are as follows:
(i) a polymer having the structure represented by the formula (FR1) in a polymer chain, and a compound having the dienophile group;
(ii) a polymer having the structure represented by the formula (FR1) in a polymer chain, and a polymer having the dienophile structure in a polymer chain; and
(iii) a polymer having both the structure represented by the formula (FR1) and the dienophile structure in a single polymer chain.

The resin composition according to the exemplary embodiment that contains, for example, any one component selected from (i), (ii), and (iii) is characterized by little change in properties because the polymer reaction is unlikely to occur at a low temperature such as room temperature (e.g., 25 degrees C.).

In the components given as examples above, the polymer having the structure represented by the formula (FR1) in a polymer chain and the polymer having both the structure represented by the formula (FR1) and the dienophile structure in a single polymer chain each have the structure represented by formula (FR1) preferably in a main chain of the polymer chain.

In the case of a composition containing the component (i) above, for example, the polymer having one or more structures represented by the formula (FR1) may not have the structure represented by the formula (FR1) bonded to at least one of one terminal or the other terminal of the polymer chain.

The number of the structures represented by the formula (FR1) present in the main chain of the polymer and the number of dienophile groups present in the compound having the dienophile structure(s) are each preferably 1 or more.

In the case of a composition containing the component (ii) above, for example, the polymer having one or more structures represented by the formula (FR1) may not have the structure represented by the formula (FR1) bonded to at least one of one terminal or the other terminal of the polymer chain, and the polymer having the dienophile structure may not have the dienophile structure bonded to at least one of one terminal or the other terminal of the polymer chain. The structure represented by the formula (FR1) and the dienophile structure may be bonded to no terminal of the polymer chain.

The total number of the structures represented by the formula (FR1) present in the main chain of the polymer and the number of the dienophile groups present in the main chain and at the terminal(s) of the polymer having the dienophile structures are each preferably 1 or more.

A bond between polymer chains formable through a reaction of the composition containing the component (ii) above can be formed by, for example, reactions as below.

(ii-1)

A reaction between a polymer having one or more dienophile structures at a terminal(s) of the polymer chain, and a polymer having one or more structures represented by the formula (FR1) in the polymer chain.

(ii-2)

A reaction between a polymer having dienophile structures at a terminal(s) and in the main chain of the polymer chain, and a polymer having one or more structures represented by the formula (FR1) in the polymer chain.

(ii-3)

A reaction between a polymer having one or more dienophile structures, and a polymer having one or more structures represented by the formula (FR1) in the polymer chain.

### Coating Liquid Composition

A coating liquid composition according to the exemplary embodiment contains the resin composition according to the exemplary embodiment and an organic solvent. That is, the coating liquid composition according to the exemplary embodiment contains the resin according to the exemplary embodiment and an organic solvent.

The coating liquid composition according to the exemplary embodiment is characterized by little change in properties at the stages of coating liquid preparation and coating liquid composition storage, because the polymer reaction is unlikely to occur at a low temperature such as room temperature (e.g., 25 degrees C.).

The organic solvent according to the exemplary embodiment can be appropriately selected in consideration of solubility of a material such as the resin composition, the drying rate after molding, the effect of a residue on a molded product, and the risk (fire or harmful effect on the health).

Examples of the organic solvent according to the exemplary embodiment include cyclic ethers (such as tetrahydrofuran (THF), dioxane, and dioxolane), cyclic ketones (such as cyclohexanone, cyclopentanone, and cycloheptanone), aromatic hydrocarbons (such as toluene, xylene, and chlorobenzene), ketones (such as methyl ethyl ketone (MEK) and methyl isobutyl ketone (MIBK)), halogenated hydrocarbons (such as dichloromethane and chloroform), esters (such as ethyl acetate, isopropyl acetate, isobutyl acetate, and butyl acetate), ethers (such as ethylene glycol dimethyl ether and ethylene glycol monoethyl ether), amides (such as dimethyl fumarate (DMF) and dimethylacetamide (DMAc), and aprotic polar solvents (such as dimethyl sulfoxide (DMSO)).

The concentration of the resin composition according to the exemplary embodiment in the coating liquid composition according to the exemplary embodiment is not limited as long as an appropriate viscosity suitable for the method of using the coating liquid composition is achieved, and is preferably in a range from 0.1 mass % to 40 mass %, more preferably in a range from 1 mass % to 35 mass %, and still more preferably in a range from 5 mass % to 30 mass %. At a concentration of 40 mass % or less, the viscosity is not excessively high, and good coatability is achieved. At a concentration of 0.1 mass % or more, a suitable viscosity can be maintained, and a homogenous film is obtained. Further, at a concentration of 0.1 mass % or more, the concentration is one suitable for reducing the drying time after coating and for easily obtaining a target film thickness.

The coating liquid composition may contain additives besides the resin composition according to the exemplary embodiment and the organic solvent. Examples of the additives include low-molecular compounds, coloring agents (such as dyes and pigments), functional compounds (such as charge transporting materials, electron transporting materials, hole transporting materials, and charge generating materials), fillers (such as inorganic or organic fillers, fibers, cloths, and fine particles), antioxidants, UV absorbents, and acid scavengers. The coating liquid composition may contain any other resin than the resin composition according to an exemplary embodiment of the invention.

As the additives and any other resin, substances known as substances that can be blended with the resin composition are usable.

When a charge transporting material is contained, in view of the product performance, a ratio between the resin composition and the charge transporting material in the coating liquid composition according to the exemplary embodiment is preferably in a range from 20:80 to 80:20, more preferably in a range from 30:70 to 70:30, by mass.

In the coating liquid composition according to the exemplary embodiment, one resin composition according to the exemplary embodiment may be used alone, or two or more resin compositions according to the exemplary embodiment may be used in combination.

Typically, the coating liquid composition according to the exemplary embodiment is suitable for use in forming a photosensitive layer of a multi-layer electrophotographic photoreceptor. The photosensitive layer of such a multi-layer electrophotographic photoreceptor preferably includes at least a charge generating layer and a charge transporting layer, and the coating liquid composition according to the exemplary embodiment is suitable for use in forming the charge transporting layer. When the charge generating material is further contained in the coating liquid composition according to the exemplary embodiment, the coating liquid composition can also be used to form a photosensitive layer of a single-layer electrophotographic photoreceptor.

The coating liquid composition is also usable to form a protective layer of the photoreceptor.

Since the resin according to the exemplary embodiment is a resin having polymer reactivity, for example, the PCs subjected to the polymer reaction by Diels-Alder reaction have excellent solution stability and are reactive at a current photoreceptor production process temperature, and the resulting resin has good abrasion resistance and does not undergo degradation of electrical characteristics. The resin according to the exemplary embodiment does not contain a radical initiator, a reaction catalyst, or the like, and is allowed to be subjected to the polymer reaction without using UV, an electron beam, or the like. Thus, deterioration in electrical properties and degradation of the charge transporting material (CTM) are inhibited.

### Molded Product

A molded product according to the exemplary embodiment contains the resin according to the exemplary embodiment. The molded product according to the exemplary embodiment is usable for various applications besides the application to an electrophotographic photoreceptor described later. The molded product according to the exemplary embodiment can be suitably used in applications to, for example, a substrate, an insulative layer, a protective layer, an adhesive layer, a conductive layer, and a structural member of an electronic device or the like. The molded product according to the exemplary embodiment is applicable also to a film, a coating film, an insulative material, and the like. The exemplary molded products herein are only necessary to include at least the resin according to the exemplary embodiment. In the molded product including the resin according to the exemplary embodiment, the resin having at least the structure represented by the formula (FR1) and the compound having the dienophile structure or the resin having the dienophile structure may be included in the same layer or in different layers. When the resin having at least the structure represented by the formula (FR1) and the compound having the dienophile structure or the resin having the dienophile structure are included in different layers, the resin having at least the structure represented by the formula (FR1) and the compound having the dienophile structure or the resin having the dienophile structure may be included in layers adjacent to each other.

Herein, a film including the resin according to the exemplary embodiment is clearly distinguished from a coating film including the resin according to the exemplary embodiment.

The film including the resin according to the exemplary embodiment, which is a resin body formed from the resin according to the exemplary embodiment, refers to a resin body of which thickness is smaller than its length and width. For example, when the film according to the exemplary embodiment is a resin body formed by coating a target with the coating material composition according to the exemplary embodiment and releasing the resultant film from the target, the resin body is defined as a film.

The coating film containing the resin according to the exemplary embodiment refers to a layer formed by coating a target with the coating material composition according to the exemplary embodiment. The coating film typically remains on the target as it is, constituting a part of a product finally obtained.

The molded product according to the exemplary embodiment is producible using the resin composition according to the exemplary embodiment.

In the case of using the resin composition according to the exemplary embodiment, either a wet molding method or a melt molding method is employable as the molding method.

When the molded product is obtained by the wet molding method, it is possible to employ (i) a method in which molding is performed at a temperature at which the polymer reaction proceeds, (ii) a method in which a wet molded product is prepared at a temperature at which the polymer reaction does not substantially proceed, the temperature is subsequently raised to a temperature at which the polymer reaction proceeds during a step of removing a solvent to simultaneously perform drying and the polymer reaction, and (iii) a method in which, at a temperature at which the polymer reaction does not substantially proceed, a dry molded product is prepared by wet molding and drying, and the temperature of the molded body is subsequently raised to a temperature at which the polymer reaction proceeds to perform the polymer reaction. Any of these method may be employed. The molding method may be a method in which a modified resin through the polymer reaction is obtained advance, a coating liquid is prepared using the modified resin to obtain the molded product.

In the wet molding method, the above-described coating liquid composition according the exemplary embodiment can be used.

In the case of performing the melt molding method, the method is usually performed at a temperature at which Diels-Alder reaction proceeds or a higher temperature. On the other hand, it is also possible to suitably employ a method in which the molding temperature is raised until retro-Diels-Alder reaction occurs to reduce the melt viscosity, thus improving fluidity. When the molding is performed under the conditions in which retro-Diels-Alder reaction occurs, the proceeding of Diels-Alder reaction can be appropriately controlled again by controlling the rate and temperature of cooling the molded product. This enables the production of a molded product formed from a resin having good molding fluidity and having improved resin physical properties due to a structure obtained by the polymer reaction.

The temperature of the polymer reaction can be appropriately determined according to the desired physical properties and intended use. The types of functional groups to be subjected to the polymer reaction, the ratio between the furan and the dienophile, the functional group concentration, and the like are adjusted according to this reaction temperature, and the cross-linking method may be determined.

In one example, regarding the temperature of polymer reaction for an electrophotographic photoreceptor, typically, it is preferable that a wet molded product be prepared by wet molding and then subjected to polymer reaction in a drying step, and the polymer reaction is required to be performed at a temperature at which a functional low-molecular compound is not degraded. For example, the temperature of polymer reaction for an electrophotographic photoreceptor is preferably in a range from 60 degrees C. to 170 degrees C., more preferably in a range from 80 degrees C. to 160 degrees C., and still more preferably in a range from 100 degrees C. to 150 degrees C. The temperature of polymer reaction for an electrophotographic photoreceptor may be in a range from 105 degrees C. to 140 degrees C., or in a range from 110 degrees C. to 130 degrees C. At a reaction temperature of higher than 170 degrees C., a functional low-molecular compound such as a charge transporting material may be degraded. A reaction temperature of lower than 60 degrees C. is not preferred because drying does not sufficiently proceed or it takes a long time for drying.

On the other hand, in the application to an electronic device, the process may be performed at a high temperature because film physical properties are adjusted by drying or the curing rate during the film formation by coating. In view of this, the reaction temperature for an electronic device is preferably in a range from 60 degrees C. to 250 degrees C., more preferably in a range from 100 degrees C. to 200 degrees C. The reaction temperature for an electronic device is still more preferably in a range from 110 degrees C. to 180 degrees C. Under the condition of a reaction temperature of higher than 250 degrees C., malfunction of an electronic component or decomposition of other organic materials may occur. At a reaction temperature of lower than 60 degrees C., the polymer reaction may not sufficiently proceed, and a material that is subjected to the reaction at such a low temperature may have a problem in stability of the coating liquid, for example, the reaction partially proceeds even in the coating liquid composition, resulting in an increase in the viscosity.

In the exemplary embodiment, the polymer reaction of the resin composition can be conducted without adding a catalyst, a polymerization initiator, or the like. However, a substance such as a catalyst or a polymerization initiator may be added for the purpose of, for example, using another polymer reaction system in combination as long as the effects of the exemplary embodiment are not impaired.

### Electrophotographic Photoreceptor

An electrophotographic photoreceptor according to the exemplary embodiment includes a layer containing the resin according to the exemplary embodiment. The resin according to the exemplary embodiment is preferably contained in an outermost layer of the electrophotographic photoreceptor according to the exemplary embodiment.

The electrophotographic photoreceptor according to the exemplary embodiment includes a substrate and a photosensitive layer disposed on the substrate and contains the resin according to the exemplary embodiment in this photosensitive layer.

The electrophotographic photoreceptor according to the exemplary embodiment may be not only any of various known types of electrophotographic photoreceptors but also any electrophotographic photoreceptor as long as the resin according to the exemplary embodiment is used in the photosensitive layer. The electrophotographic photoreceptor according to the exemplary embodiment is preferably a multi-layer electrophotographic photoreceptor in which the photosensitive layer includes at least one charge generating layer and at least one charge transporting layer or a single-layer electrophotographic photoreceptor including a single layer that contains a charge generating material and a charge transporting material therein. The electrophotographic photoreceptor according to the exemplary embodiment that includes the layer containing the resin according to the exemplary embodiment has excellent abrasion resistance and does not undergo degradation of the residual potential. Further, the electrophotographic photoreceptor according to the exemplary embodiment that includes the layer containing the resin according to the exemplary embodiment has good solvent resistance and is unlikely to be subjected to mechanical degradation.

The resin according to the exemplary embodiment may be used in any portion in the photosensitive layer. To sufficiently exhibit the effect of the exemplary embodiment, the resin according to the exemplary embodiment is preferably used as a binder resin of a charge transferring material in the charge transporting layer or a binder resin of the single-layer photosensitive layer. It is desirable that the resin according to the exemplary embodiment be used not only as a photosensitive layer but also as a surface protective layer. In the case of a multi-layer electrophotographic photoreceptor including two charge transporting layers, the resin according to the exemplary embodiment is preferably used in one of the charge transporting layers.

In the electrophotographic photoreceptor according to the exemplary embodiment, resins according to the exemplary embodiment may be used alone or in combination of two or more thereof. A binder resin component such as another polycarbonate may further be contained if required as long as the objects of the exemplary embodiment are not impaired. Further, an additive such as an antioxidant may be contained.

The electrophotographic photoreceptor according to the exemplary embodiment includes a photosensitive layer on a conductive substrate. When the photosensitive layer has a charge generating layer and a charge transporting layer, the charge transporting layer may be stacked on the charge generating layer, or conversely, the charge generating layer may be stacked on the charge transporting layer. Alternatively, the photosensitive layer may be a single layer that contains both a charge generating material and a charge transporting material therein. Further, a conductive or insulating protective film may be formed as a surface layer if necessary. When the resin according to the exemplary embodiment is used in the outermost layer, an electrophotographic photoreceptor having good solvent resistance and abrasion resistance can be provided.

Furthermore, for example, an intermediate layer such as an adhesion layer for improving adhesiveness between layers or a blocking layer having a function of blocking charges may be formed.

Various materials such as known materials can be used as the material of the conductive substrate used in the electrophotographic photoreceptor of the exemplary embodiment. Specific examples of the material that can be used include a plate, a drum, and a sheet formed of aluminum, nickel, chromium, palladium, titanium, molybdenum, indium, gold, platinum, silver, copper, zinc, brass, stainless steel, lead oxide, tin oxide, indium oxide, ITO (indium tin oxide: tin-doped indium oxide) or graphite; a film, a sheet, and a seamless belt formed of glass, cloth, paper, or plastic having been subjected to conductive treatment through, for example, coating by vapor deposition, sputtering, application, or the like; and a metal drum having been subjected to metal oxidation treatment by electrode oxidation or the like.

The charge generating layer contains at least a charge generating material. The charge generating layer can be obtained by forming a layer from the charge generating material on the underlying substrate by vacuum deposition, sputtering, or the like or by forming, on the underlying substrate, a layer in which the charge generating material is bound with a binder resin. Various methods such as known methods can be employed as the method for forming the charge generating layer using a binder resin. Typically, for example, the charge generating layer is suitably obtained as a wet molded body by a method including applying, onto a predetermined underlying substrate, a coating liquid composition in which a charge generating material is dispersed or dissolved in a suitable solvent together with a binder resin, followed by drying.

Various known materials can be used as the charge generating material in the charge generating layer. Examples of specific compounds include elemental selenium (such as amorphous selenium and trigonal selenium), selenium alloys (such as selenium-tellurium), selenium compounds and selenium-containing compositions (such as As₂Se₃), inorganic materials formed of a group 12 element and a group 16 element in the periodic table (such as zinc oxide and CdS—Se), oxide-based semiconductors (such as titanium oxide), silicon-based materials (such as amorphous silicon), metal-free phthalocyanine pigments (such as τ-type metal-free phthalocyanine and χ-type metal-free phthalocyanine), metal phthalocyanine pigments (such as α-type copper phthalocyanine, β-type copper phthalocyanine, γ-type copper phthalocyanine, ε-type copper phthalocyanine, X-type copper phthalocyanine, A-type titanyl phthalocyanine, B-type titanyl phthalocyanine, C-type titanyl phthalocyanine, D-type titanyl phthalocyanine, E-type titanyl phthalocyanine, F-type titanyl phthalocyanine, G-type titanyl phthalocyanine, H-type titanyl phthalocyanine, K-type titanyl phthalocyanine, L-type titanyl phthalocyanine, M-type titanyl phthalocyanine, N-type titanyl phthalocyanine, Y-type titanyl phthalocyanine, Y-type oxotitanyl phthalocyanine, α-type oxotitanyl phthalocyanine, β-type oxotitanyl phthalocyanine, titanyl phthalocyanine having a strong diffraction peak at a Bragg angle 2θ of 27.3±0.2 degrees in an X-ray diffraction pattern, and gallium phthalocyanine), cyanine dyes, anthracene pigments, bisazo pigments, pyrene pigments, polycyclic quinone pigments, quinacridone pigments, indigo pigments, perylene pigments, pyrylium dyes, squarylium pigments, anthanthrone pigments, benzimidazole pigments, azo pigments, thioindigo pigments, quinoline pigments, lake pigments, oxazine pigments, dioxazine pigments, triphenylmethane pigments, azulenium dyes, triarylmethane dyes, xanthine dyes, thiazine dyes, thiapyrylium dyes, polyvinyl carbazole, and bisbenzimidazole pigments. These compounds may be used, as the charge generating material, alone or as a mixture of two or more compounds. Of these charge generating materials, charge generating materials specifically disclosed in JP-H11-172003A are examples of preferred charge generating materials.

The charge transporting layer can be obtained as a wet molded body by forming, on the underlying substrate, a layer in which a charge transporting material is bound with a binder resin.

No particular limitation is imposed on the binder resin in at least one of the charge generating layer or the charge transporting layer, and various known resins can be used. Specific examples thereof include polystyrene, polyvinyl chloride, polyvinyl acetate, vinyl chloride-vinyl acetate copolymer, polyvinyl acetal, alkyd resin, acrylic resin, polyacrylonitrile, polycarbonate, polyurethane, epoxy resin, phenolic resin, polyamide, polyketone, polyacrylamide, butyral resin, polyester resin, vinylidene chloride-vinyl chloride copolymer, methacrylic resin, styrene-butadiene copolymer, vinylidene chloride-acrylonitrile copolymer, vinyl chloride-vinyl acetate-maleic anhydride copolymer, silicone resin, silicone-alkyd resin, phenol-formaldehyde resin, styrene-alkyd resin, melamine resin, polyether resin, benzoguanamine resin, epoxy-acrylate resin, urethane-acrylate resin, poly-N-vinylcarbazole, polyvinyl butyral, polyvinyl formal, polysulfone, casein, gelatine, polyvinyl alcohol, ethyl cellulose, nitrocellulose, carboxy-methyl cellulose, vinylidene chloride-based polymer latex, acrylonitrile-butadiene copolymer, vinyltoluene-styrene copolymer, soybean oil-modified alkyd resin, nitrated polystyrene, polymethylstyrene, polyisoprene, polythiocarbonate, polyarylate, polyhaloarylate, polyallyl ether, polyvinyl acrylate, and polyester acrylate.

These may be used alone or as a mixture of two or more thereof. Note that the above-described PC polymer of the exemplary embodiment is suitably used as the binder resin in at least one of the charge generating layer or the charge transporting layer.

Various known methods can be employed as the method for forming the charge transporting layer. The charge transporting layer is suitably obtained as a wet molded body by a method including applying, onto a predetermined underlying substrate, a coating liquid composition in which a charge transporting material is dispersed or dissolved in a suitable solvent together with the PC polymer of the exemplary embodiment, followed by drying A blend ratio between the charge transporting material and the PC polymer (charge transporting material:PC polymer) used to form the charge transporting layer is preferably in a range from 20:80 to 80:20, more preferably in a range from 30:70 to 70:30, by mass.

In this charge transporting layer, PC polymers of the exemplary embodiment may be used alone or as a mixture of two or more thereof. In addition, another binder resin may be used in combination with the PC polymer of the exemplary embodiment as long as the objects of the invention are not impaired.

Typically, the thickness of the charge transporting layer formed in this manner is approximately in a range from 5 μm to 100 μm, preferably in a range from 10 μm to 50 μm, more preferably in a range from 15 μm to 40 μm. When the thickness is 5 μm or more, the initial potential is not lowered. When the thickness is 100 μm or less, degradation of electrophotographic characteristics can be prevented.

Various known compounds can be used as the charge transporting material that can be used together with the PC polymer of the exemplary embodiment. Examples of such compounds that are suitably used include carbazole compounds, indole compounds, imidazole compounds, oxazole compounds, pyrazole compounds, oxadiazole compounds, pyrazoline compounds, thiadiazole compounds, aniline compounds, hydrazone compounds, aromatic amine compounds, aliphatic amine compounds, stilbene compounds, fluorenone compounds, butadiene compounds, quinone compounds, quinodimethane compounds, thiazole compounds, triazole compounds, imidazolone compounds, imidazolidine compounds, bisimidazolidine compounds, oxazolone compounds, benzothiazole compounds, benzimidazole compounds, quinazoline compounds, benzofuran compounds, acridine compounds, phenazine compounds, poly-N-vinylcarbazole, polyvinylpyrene, polyvinylanthracene, polyvinylacridine, poly-9-vinylphenylanthracene, pyrene-formaldehyde resin, ethylcarbazole resin, and polymers having any of the aforementioned structures in the main chain or a side chain. These compounds may be used alone or in combination of two or more thereof.

Of these charge transporting materials, compounds specifically disclosed as examples in JP-H11-172003A and charge transporting materials represented by structures below are particularly suitably used.

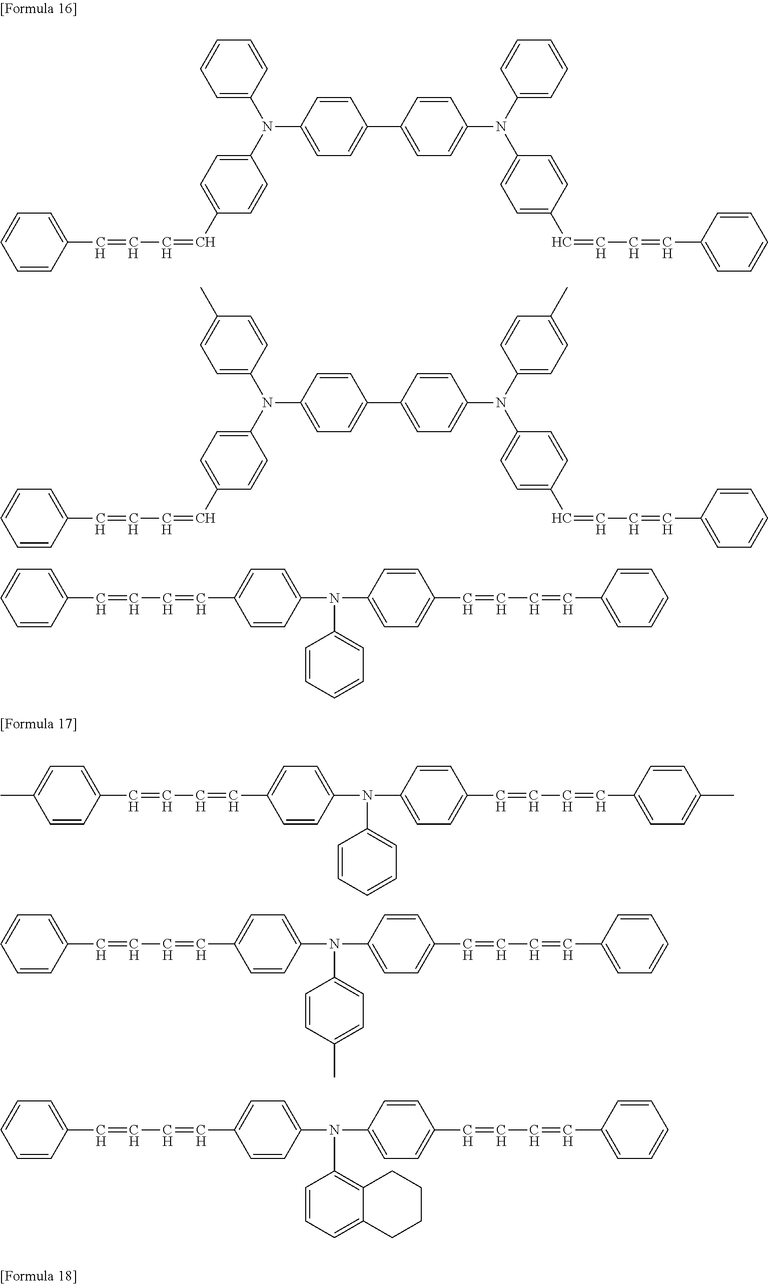

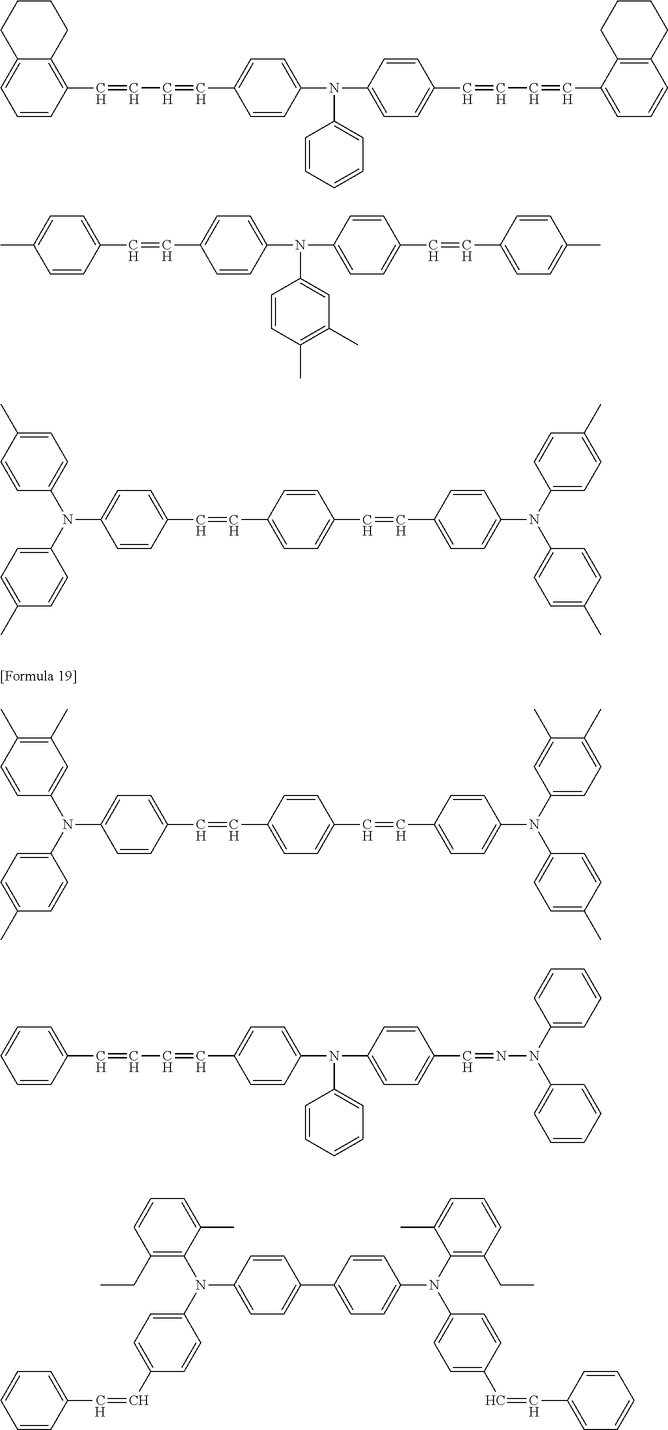

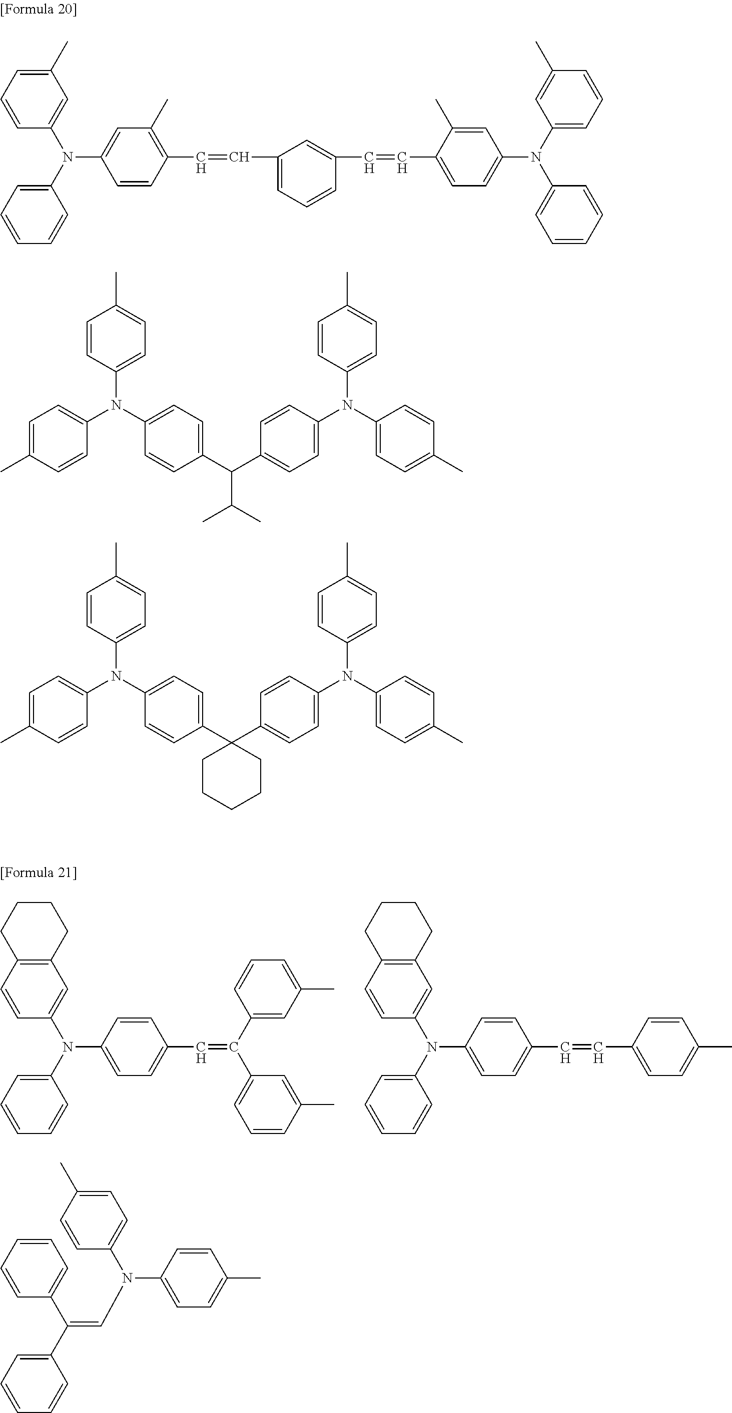

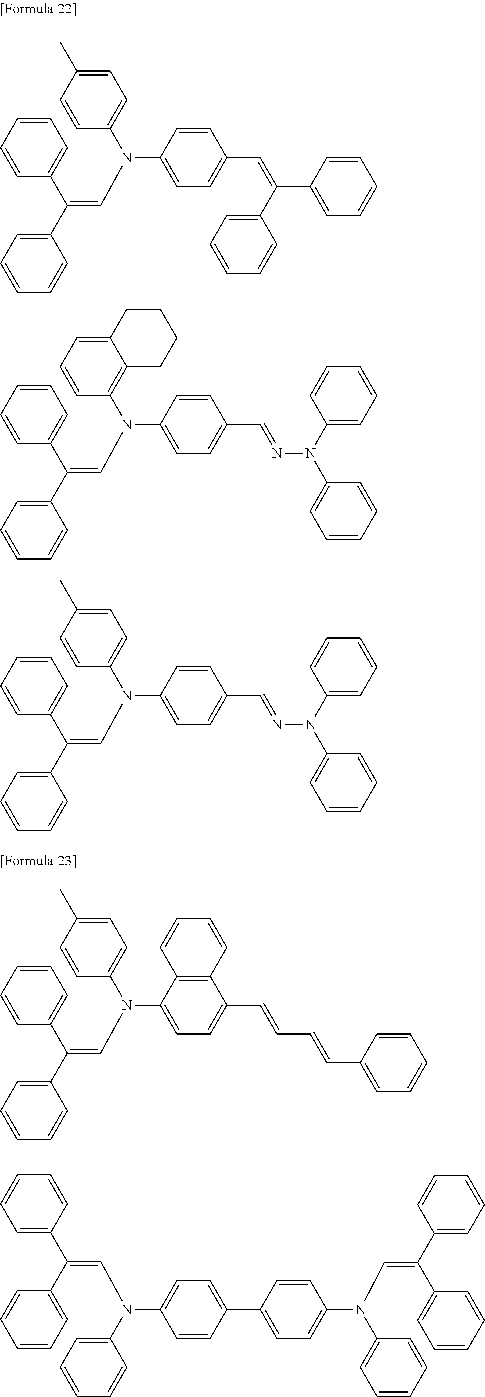

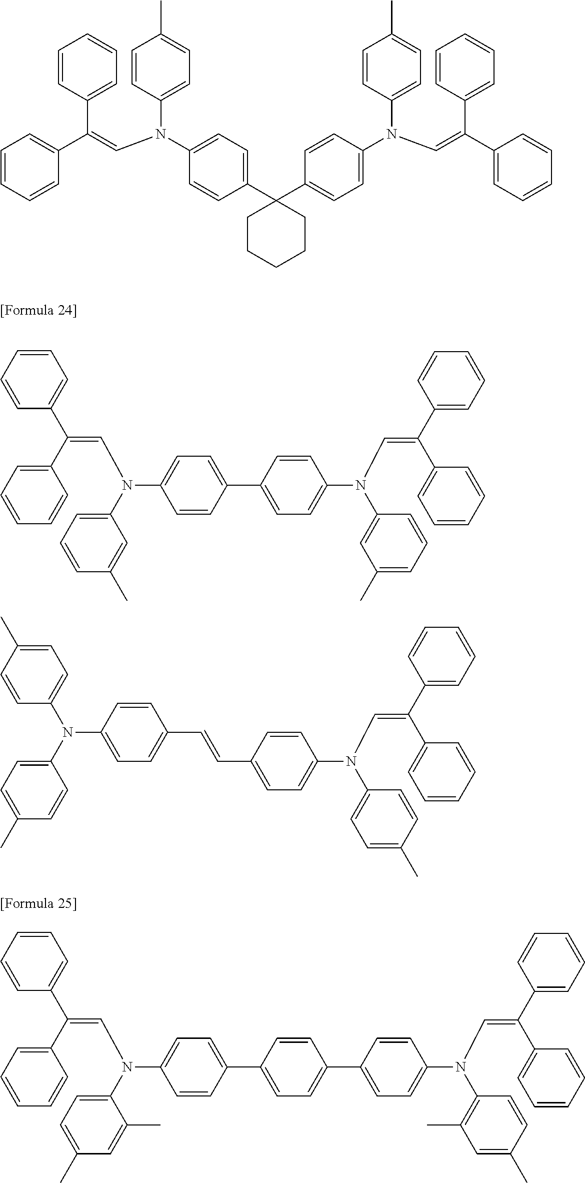 [SMILES: Cc1ccc(N(C=C(c2ccccc2)c2ccccc2)c2ccc(C3(c4ccc(N(C=C(c5ccccc5)c5ccccc5)c5ccc(C)cc5)cc4)CCCCC3)cc2)cc1 ; Cc1cccc(N(C=C(c2ccccc2)c2ccccc2)c2ccc(-c3ccc(N(C=C(c4ccccc4)c4ccccc4)c4cccc(C)c4)cc3)cc2)c1 ; Cc1ccc(N(C=C(c2ccccc2)c2ccccc2)c2ccc(/C=C/c3ccc(N(c4ccc(C)cc4)c4ccc(C)cc4)cc3)cc2)cc1 ; Cc1ccc(N(C=C(c2ccccc2)c2ccccc2)c2ccc(-c3ccc(-c4ccc(N(C=C(c5ccccc5)c5ccccc5)c5ccc(C)cc5C)cc4)cc3)cc2)c(C)c1]

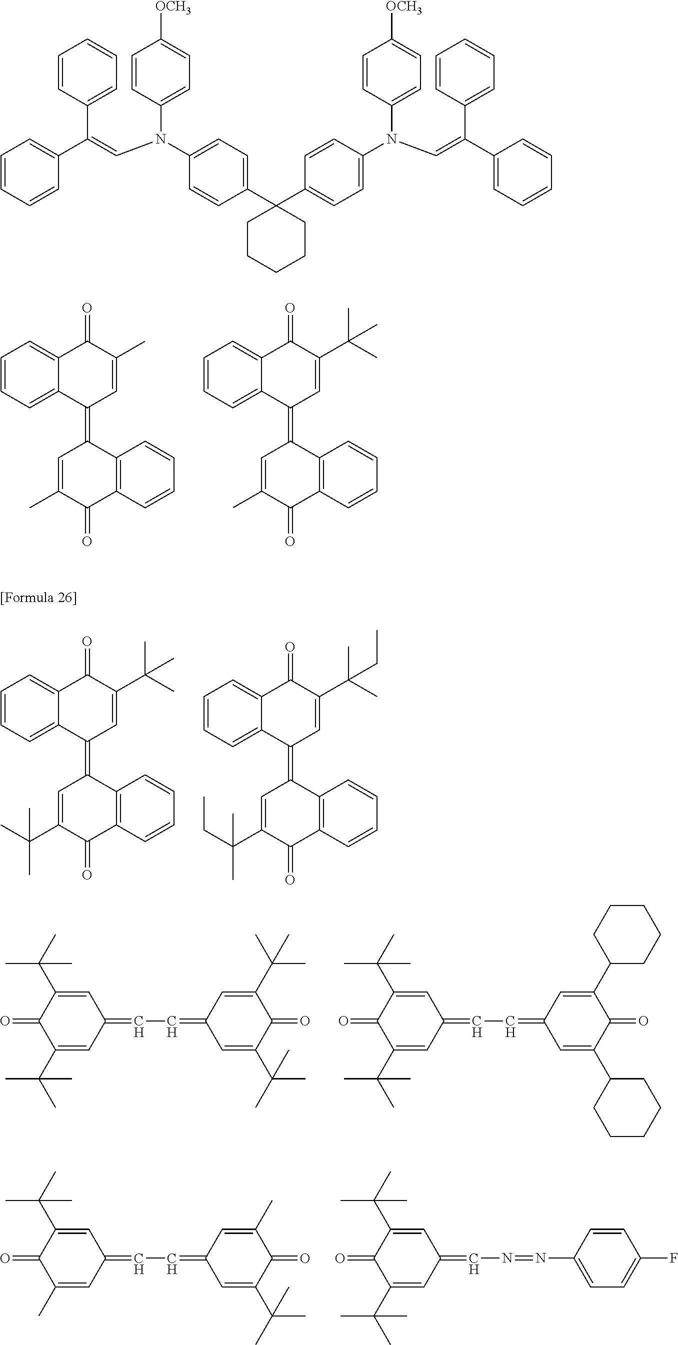

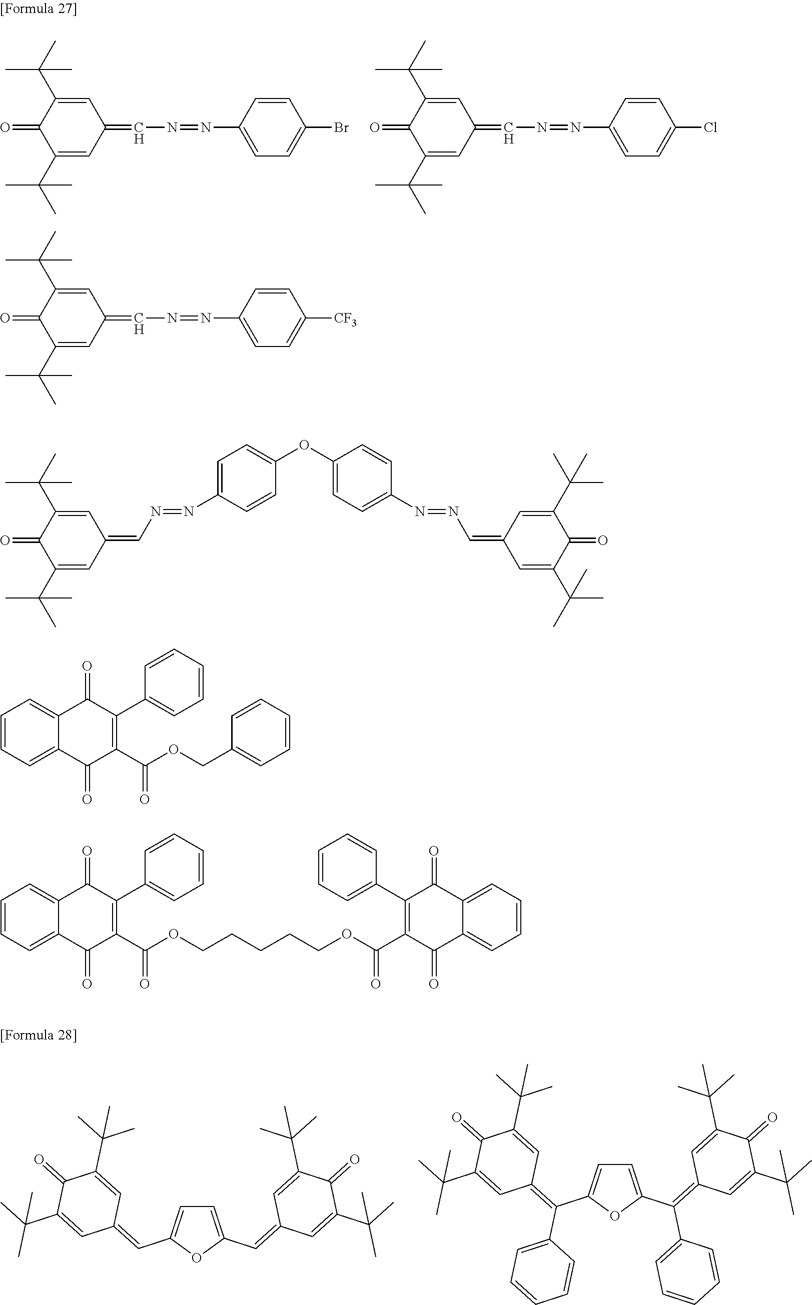

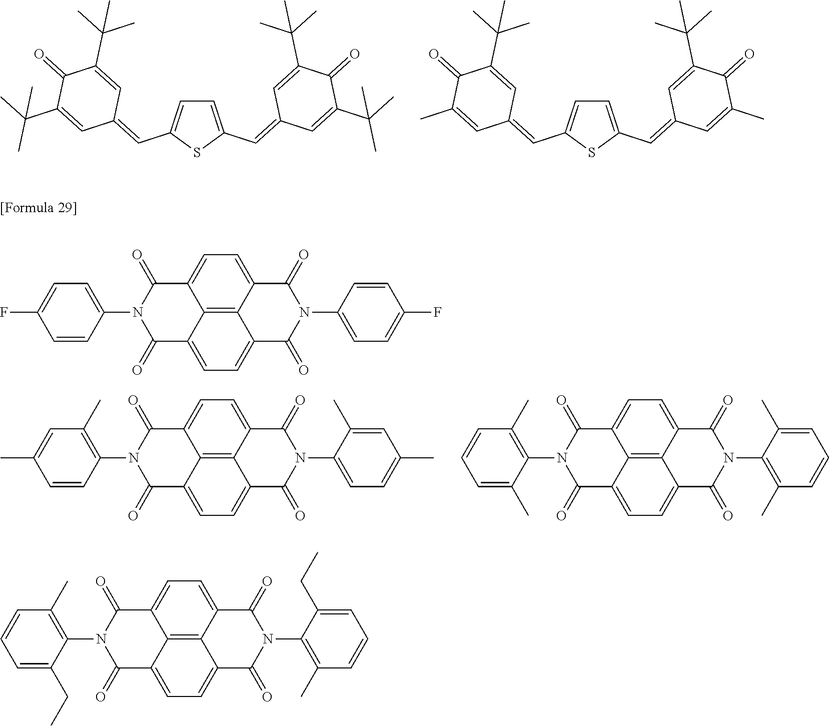

Note that, in the electrophotographic photoreceptor according to the exemplary embodiment, the resin composition according to the exemplary embodiment is suitably used as a binder resin in at least one of the charge generating layer, the charge transporting layer, or the surface protective layer.

The electrophotographic photoreceptor according to the exemplary embodiment may include a typically used undercoat layer between the conductive substrate and the photosensitive layer. Examples of components of the undercoat layer that can be used include fine particles (such as titanium oxide, aluminum oxide, zirconia, titanic acid, zirconic acid, lanthanum lead, titanium black, silica, lead titanate, barium titanate, tin oxide, indium oxide, and silicon oxide), polyamide resin, phenolic resin, casein, melamine resin, benzoguanamine resin, polyurethane resin, epoxy resin, cellulose, nitrocellulose, polyvinyl alcohol, and polyvinyl butyral resin. As the resin used for this undercoat layer, the binder resin described above may be used, or the resin composition according to the exemplary embodiment may be used. The above fine particles and resins may be used alone, or a variety thereof may be mixed for use. When the fine particles and the resins are used as a mixture, inorganic fine particles and a resin are preferably used in combination because a film having good smoothness is formed.

The thickness of the undercoat layer is in a range from 0.01 μm to 10 μm, preferably in a range from 0.1 μm to 7 μm. When the thickness is 0.01 μm or more, the undercoat layer can be uniformly formed. When the thickness is 10 μm or less, degradation of electrophotographic characteristics can be restrained.

A typically used known blocking layer may be disposed between the conductive base and the photosensitive layer. The same type of resin as the above-described binder resin may be used for the blocking layer. The resin composition according the exemplary embodiment may be used. The thickness of the blocking layer is in a range from 0.01 μm to 20 μm, preferably in a range from 0.1 μm to 10 μm. When the thickness is 0.01 μm or more, the blocking layer can be uniformly formed. When the thickness is 20 μm or less, degradation of electrophotographic characteristics can be restrained.

Further, the electrophotographic photoreceptor according to the exemplary embodiment may include a protective layer stacked on the photosensitive layer. The same type of resin as the above-described binder resin may be used for the protective layer. The resin composition according the exemplary embodiment is particularly preferably used. The thickness of the protective layer is in a range from 0.01 μm to 20 μm, preferably in a range from 0.1 μm to 10 μm. This protective layer may contain the charge generating material, the charge transporting material, additives, metal and oxides, nitrides, or salts thereof, alloys, carbon black, and a conductive material such as an organic conductive compound.

Furthermore, in order to improve the performance of this electrophotographic photoreceptor, a binding agent, a plasticizer, a curing catalyst, a fluidity-imparting agent, a pinhole-controlling agent, and a spectral-sensitivity sensitizer (sensitizer dye), and the like may be added to the charge generating layer and the charge transporting layer as long as the effects of the invention are not lost. Furthermore, in order to prevent an increase in the residual potential, a reduction in the charged potential, and a decrease in the sensitivity due to repeated use, various chemical substances and additives such as an antioxidant, a surfactant, an anti-curling agent, and a leveling agent may be added.

Examples of the binding agent include silicone resin, polyamide resin, polyurethane resin, polyester resin, epoxy resin, polyketone resin, polycarbonate copolymer, polystyrene resin, polymethacrylate resin, polyacrylamide resin, polybutadiene resin, polyisoprene resin, melamine resin, benzoguanamine resin, polychloroprene resin, polyacrylonitrile resin, ethyl cellulose resin, nitrocellulose resin, urea resin, phenolic resin, phenoxy resin, polyvinyl butyral resin, formal resin, vinyl acetate resin, vinyl acetate/vinyl chloride copolymer resin, and polyester carbonate resin. At least one of thermosetting resin or photo-curable resin can also be used. In any case, there is no particular limitation as long as the binding agent is an electrically insulating resin with which a film can be formed under ordinary conditions, and as long as the effects of the exemplary embodiment are not impaired.

Specific examples of the plasticizer include biphenyl, chlorinated biphenyl, o-terphenyl, halogenated paraffin, dimethylnaphthalene, dimethyl phthalate, dibutyl phthalate, dioctyl phthalate, diethylene glycol phthalate, triphenyl phosphate, diisobutyl adipate, dimethyl sebacate, dibutyl sebacate, butyl laurate, methyl phthalyl ethyl glycolate, dimethyl glycol phthalate, methylnaphthalene, benzophenone, polypropylene, polystyrene, and fluorohydrocarbon.

Specific examples of the curing catalyst include methanesulfonic acid, dodecylbenzenesulfonic acid, and dinonylnaphthalene disulfonic acid. Examples of the fluidity-imparting agent include Modaflow and Acronal 4F. Examples of the pinhole-controlling agent include benzoin and dimethyl phthalate. The plasticizer, curing catalyst, fluidity-imparting agent, and pinhole-controlling agent are preferably used in an amount of 5 mass % or less relative to the charge transporting material as long as the effects of the invention are not lost.

When a sensitizer dye is used as the spectral-sensitivity sensitizer, suitable examples of the sensitizer dye include triphenylmethane-based dyes (such as methyl violet, crystal violet, night blue, and victoria blue), acridine dyes (such as erythrosine, Rhodamine B, Rhodamine 3R, acridine orange, and frapeosine), thiazine dyes (such as methylene blue and methylene green), oxazine dyes (such as capri blue and meldola blue), cyanine dyes, merocyanine dyes, styryl dyes, pyrylium salt dyes, and thiopyrylium salt dyes.

In order to, for example, enhance the sensitivity, reduce the residual potential, and reduce fatigue due to repeated use, an electron-accepting substance may be added to the photosensitive layer as long as the effects of the invention are not lost. Specific examples thereof preferably include compounds having high electron affinity, such as succinic anhydride, maleic anhydride, dibromomaleic anhydride, phthalic anhydride, tetrachlorophthalic anhydride, tetrabromophthalic anhydride, 3-nitrophthalic anhydride, 4-nitrophthalic anhydride, pyromellitic anhydride, mellitic anhydride, tetracyanoethylene, tetracyanoquinodimethane, o-dinitrobenzene, m-dinitrobenzene, 1,3,5-trinitrobenzene, p-nitrobenzonitrile, picryl chloride, quinone chlorimide, chloranil, bromanil, benzoquinone, 2,3-dichlorobenzoquinone, dichlorodicyanoparabenzoquinone, naphthoquinone, diphenoquinone, tropoquinone, anthraquinone, 1-chloroanthraquinone, dinitroanthraquinone, 4-nitrobenzophenone, 4,4′-dinitrobenzophenone, 4-nitrobenzal malonodinitrile, ethyl α-cyano-β-(p-cyanophenyl) acrylate, 9-anthracenyl methylmalonodinitrile, 1-cyano-(p-nitrophenyl)-2-(p-chlorophenyl)ethylene, 2,7-dinitrofluorenone, 2,4,7-trinitrofluorenone, 2,4,5,7-tetranitrofluorenone, 9-fluorenylidene-(dicyanomethylene malononitrile), polynitro-9-fluorenylidene-(dicyanomethylene malonodinitrile), picric acid, o-nitrobenzoic acid, p-nitrobenzoic acid, 3,5-dinitrobenzoic acid, pentafluorobenzoic acid, 5-nitrosalicylic acid, 3,5-dinitrosalicylic acid, phthalic acid, and mellitic acid. Any of these compounds may be added to either the charge generating layer or the charge transporting layer. A blend ratio of the compound is in a range from 0.01 parts by mass to 200 parts by mass, preferably in a range from 0.1 parts by mass to 50 parts by mass when the amount of the charge generating material or charge transporting material is 100 parts by mass, as long as the effects of the invention are not lost.

Furthermore, in order to improve surface quality, for example, tetrafluoroethylene resin, chlorotrifluoroethylene resin, tetrafluoroethylene hexafluoropropylene resin, vinyl fluoride resin, vinylidene fluoride resin, dichlorodifluoroethylene resin, copolymers thereof, and a fluorine-containing graft polymer may be used as long as the effects of the invention are not lost. A blend ratio of the surface modifier is in a range from 0.1 mass % to 60 mass %, preferably in a range from 5 mass % to 40 mass % relative to the binder resin as long as the effects of the invention are not lost. At a blend ratio of 0.1 mass % or more, surface modifications such as surface durability and a reduction in surface energy are sufficiently achieved. At a blend ratio of 60 mass % or less, degradation of electrophotographic characteristics is not caused.

Preferred examples of the antioxidant include hindered phenol antioxidants, aromatic amine antioxidants, hindered amine antioxidants, sulfide antioxidants, and organophosphate antioxidants. A blend ratio of the antioxidant is usually in a range from 0.01 mass % to 10 mass %, preferably in a range from 0.1 mass % to 2 mass % relative to the charge transporting material as long as the effects of the invention are not lost.

Specific examples of the antioxidant preferably include compounds represented by [Formula 94] to [Formula 101] disclosed in the Specification of JP-H11-172003A.

These antioxidants may be used alone or as a mixture of two or more thereof. These may be added to the surface protective layer, the undercoat layer, and the blocking layer in addition to the photosensitive layer.

Specific examples of the solvent used in the formation of at least one of the charge generating layer or the charge transporting layer include aromatic solvents (such as benzene, toluene, xylene, and chlorobenzene), ketones (such as acetone, methyl ethyl ketone, and cyclohexanone), alcohols (such as methanol, ethanol, and isopropanol), esters (such as ethyl acetate and ethyl cellosolve), halogenated hydrocarbons (such as carbon tetrachloride, carbon tetrabromide, chloroform, dichloromethane, and tetrachloroethane), ethers (such as tetrahydrofuran, dioxolane, and dioxane), sulfoxides (such as dimethyl sulfoxide), and amides (such as dimethylformamide and diethylformamide). These solvents may be used alone or as a mixed solvent of two or more thereof.

The photosensitive layer of a single-layer electrophotographic photoreceptor can be easily formed by applying the resin composition according to the exemplary embodiment as the binder resin with the use of the charge generating material, the charge transporting material, and the additives. At least one of the above-described hole transporting material or electron transporting material is preferably added to the charge transporting material. Electron transporting materials disclosed as examples in JP2005-139339A are preferably used as the electron transporting material.

Application of each layer can be performed with an application device such as a known device. Specifically, the application can be performed with, for example, an applicator, a spray coater, a bar coater, a chip coater, a roll coater, a dip coater, a doctor blade, or the like.

The thickness of the photosensitive layer in the electrophotographic photoreceptor is in a range from 5 μm to 100 μm, preferably in a range from 8 μm to 50 μm. When the thickness is 5 μm or more, a decrease in the initial potential can be prevented. When the thickness is 100 μm or less, degradation of electrophotographic characteristics can be inhibited. A ratio of charge generating material:resin composition used in the production of the electrophotographic photoreceptor is preferably in a range from 20:80 to 80:20, more preferably in a range from 30:70 to 70:30, by mass.

The electrophotographic photoreceptor obtained as described above includes, as a binder resin in the photosensitive layer, the resin formed from the resin composition according to the exemplary embodiment and modified through the polymer reaction. Thus, the electrophotographic photoreceptor exhibits good properties such as durability and has good electrical characteristics (electrophotographic characteristics) to maintain good electrophotographic characteristics for a long period of time. Accordingly, the electrophotographic photoreceptor is suitable for use in various electrophotographic fields such as copiers (monochrome, multi-color, full-color, analog, and digital copiers), printers (laser, LED, and liquid-crystal shutter printers), facsimile machines, platemakers, and devices having a function of a plurality of these.

### Method for Producing Electrophotographic Photoreceptor

A method for producing an electrophotographic photoreceptor according to the exemplary embodiment is a method including: applying the coating liquid composition according to the exemplary embodiment to a conductive base by a wet molding method; removing the organic solvent in the coating liquid composition by performing heating; and conducting a polymer reaction of the resin composition in the coating liquid composition either simultaneously with the heating in the removal of the organic solvent or by continuously performing heating.

In the application of the coating liquid composition to the conductive base, the coating thickness of the coating liquid composition can be appropriately determined according to the thickness of the photosensitive layer of the electrophotographic photoreceptor according to the exemplary embodiment.

In the removal of the organic solvent, the conditions can be appropriately determined according to the type of the organic solvent in the coating liquid composition according to the exemplary embodiment.

In the polymer reaction of the resin composition, the heating temperature is the same as the reaction temperature for an electrophotographic photoreceptor in the molded product according to the exemplary embodiment.

### EXAMPLES

Next, the invention will be described in more detail with reference to Examples and Comparative Examples. However, the invention is not limited to these Examples, and various modifications and applications can be made without departing from the spirit of the invention.

### Measurement of Oxygen Concentration

Air calibration was performed using a DO meter MODEL B-506 produced by Iijima Electronics Corporation with WAGNIT (WA-BRP) as a probe. Then, zero-point calibration was performed with an aqueous solution of 25 g of sodium sulfite dissolved in 500 mL of ion-exchanged water. Thereafter, a value read in a DO measurement mode was determined as the oxygen concentration. The above method was used to determine oxygen concentrations in all of a gas phase, a methylene chloride layer and an aqueous layer.

### Production Example: Preparation of Monomer

### Production Example 1: Synthesis of 2-(2-furanylmethyl)hydroquinone

A reaction container equipped with a mechanical stirrer, a stirring blade, a baffle plate, and a reflux pipe was replaced with Ar, and 123 g of furfural, 54.3 g of lithium chloride, and pyridine (718 mL) were put thereinto and heated for reflux for 2.5 hours.

The reaction solution was allowed to cool, followed by addition of ion-exchanged water (1 L), and the mixture was subjected to extraction with ethyl acetate (1 L) twice.

The organic layer was washed with a 2N—HCl aqueous solution once and with ion-exchanged water three times. Then, the organic layer was separated, dried with Na₂SO₄, filtered, and concentrated to give 280 g of an oily compound.

The obtained crude product was subjected to two cycles of column chromatography on silica gel (hexane:ethyl acetate=3:1) to give 2-(2-furanylmethyl)hydroquinone (85 g) with 99% purity.

### Production Example: Preparation of Oligomer

### Production Example 2: Synthesis of Bisphenol Z Oligomer (Bischloroformate)

In 1,080 mL of methylene chloride, 60.0 g (224 mmol) of 1,1-bis(4-hydroxyphenyl)cyclohexane (bisphenol Z) was suspended, and 66.0 g (667 mmol) of phosgene was added thereto to achieve dissolution. To this, a liquid in which 44.0 g (435 mmol) of triethylamine was dissolved in 120 mL of methylene chloride was added dropwise in a temperature range from 5 degrees C. to 15 degrees C. Next, stirring was performed for 30 minutes, and methylene chloride was then distilled off until the concentration thereof reached a predetermined value. To the residual liquid, 210 mL of pure water, 1.2 g of concentrated hydrochloric acid, and 450 mg of hydrosulfite were added, and washing was performed. Subsequently, washing was repeated with 210 mL of pure water five times to obtain a methylene chloride solution of a bisphenol Z oligomer having chloroformate groups at molecular terminals. The obtained solution had a chloroformate concentration of 1.12 mol/L, a solid concentration of 0.225 kg/L, and an average number of repeating units of 1.03. Hereinafter, this resulting raw material is referred to as Z—CF.

The average number of repeating units (n_{X}) of a bischloroformate compound represented by a formula (X1) below was determined using the following numerical formula (Numerical Formula 1).

Average number of repeating units (n_{X})=1+(Mav−M1)/M2 (Numerical Formula 1)

In the numerical formula (Numerical Formula 1), Mav is (2×1000/(CF value)), M2 is (M1−98.92), M1 is a molecular weight of the bischloroformate compound when n_{X} is equal to 1 in the formula (X1) below, CF value (N/kg) is (CF number/concentration), CF number (N) is the number of chlorine atoms in the bischloroformate compound represented by the formula (X1) below and contained in 1 L of the reaction solution, and concentration (kg/L) is an amount of solid component obtained by concentrating 1 L of the reaction solution. Here, 98.92 is an atomic weight of the total of two chlorine atoms, one oxygen atom, and one carbon atom that are eliminated by polycondensation between bischloroformate compound molecules.

When a bischloroformate is synthesized using two or more types of raw materials and the average number of repeating units thereof is determined, M1 is calculated on the basis of a molecular weight determined by averaging the molecular weights of the raw materials used in terms of molar ratio, and the average number of repeating units is determined. In one example, when synthesis is performed using 366 moles of a monomer having a molecular weight of 268 and 108 moles of another monomer having a molecular weight of 214, M1=(268×(366/(366+108))+214×(108/(366+108))+124.9 is satisfied.

In this calculation formula for M1, “124.9” is an increment of the molecular weight when two hydrogen atoms of the monomers used are lost, and two carbon atoms, two oxygen atoms, and two chlorine atoms thereof are increased.

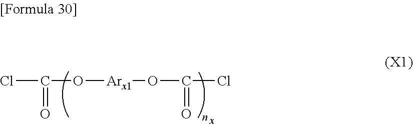

In the formula (X1), Ar_{X1} is a divalent group. For example, in a case of the bischloroformate compound (bisphenol Z oligomer) according to Production Example 2, the divalent group represented by a formula (10) below corresponds to Ar_{X1}.

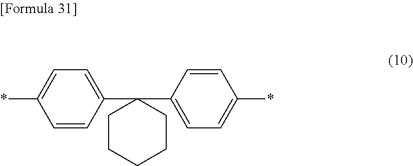 [SMILES: *c1ccc(C2(c3ccc(*)cc3)CCCCC2)cc1]

In a case of the bischloroformate oligomer represented by the formula (1A) above, Ar₃₃ corresponds to Ar_{X1}, and n31 corresponds to n_{X}.

In a case of the bischloroformate oligomer represented by the formula (2A) above, Ar₃₄ corresponds to Ar_{X1}, and n32 corresponds to n_{X}.

### Production Example 3: Synthesis of Bisphenol Z/3,3′-Dimethyl-4,4′-Dihydroxybiphenyl Oligomer (Bischloroformate)

In 2,400 mL of methylene chloride, 98 g (366 mmol) of 1,1-bis(4-hydroxyphenyl)cyclohexane (bisphenol Z) and 22 g (103 mmol) of 3,3′-dimethyl-4,4′-dihydroxybiphenyl were suspended, and 138 g (1,395 mmol) of phosgene was added thereto to achieve dissolution. To this, a liquid in which 93.8 g (929 mmol) of triethylamine was dissolved in 256 mL of methylene chloride was added dropwise in a temperature range from 16 degrees C. to 19 degrees C. Next, stirring was performed for 140 minutes, and methylene chloride was then distilled off until the concentration thereof reached a predetermined value. To the residual liquid, 1,100 mL of pure water, 2.4 g of concentrated hydrochloric acid, and 450 mg of hydrosulfite were added, and washing was performed. Subsequently, washing was repeated with 210 mL of pure water five times to obtain a methylene chloride solution of a bisphenol Z oligomer and 3,3′-dimethyl-4,4′-dihydroxybiphenyl oligomer having chloroformate groups at molecular terminals. The obtained solution had a chloroformate concentration of 0.57 mol/L, a solid concentration of 0.11 kg/L, and an average number of repeating units of 1.02. Hereinafter, this resulting raw material is referred to as OCBP-CF.

### Synthesis Example 1

### Production of PC Polymer

ZOCBP-CF (49 mL) of Production Example 3 and methylene chloride (11 mL) were poured into a reaction container equipped with a mechanical stirrer, a stirring blade, and a baffle plate. To this, p-tert-butylphenol (hereinafter denoted by PTBP) (0.05 g) serving as a terminal terminator and 2-(2-furanylmethyl)hydroquinone (1.06 g) synthesized above were added and stirred for 20 minutes to be sufficiently mixed while nitrogen gas was blown into the gas phase of the reaction container at a flow rate of 0.2 L/min. After the oxygen concentration value of the gas phase read in a DO mode of a dissolved oxygen meter (DO meter MODEL B-506, manufactured by Iijima Electronics Corporation) was 0.5 mg/L or less, a measurement probe was immersed into the reaction solution to measure the oxygen concentration in the solution, and the reading was confirmed to be 0.5 mg/L or less as in the gas phase. After cooling was performed until the temperature inside the reaction container was 10 degrees C., a 1.4 N aqueous potassium carbonate solution (prepared by dissolving 0.97 g of potassium carbonate in ion-exchange water (5 mL) and adding 50 mg of sodium hydrosulfite) was added to the reaction solution, and 0.8 mL of an aqueous triethylamine solution (7 vol %) was added thereto while stirring, and stirring was continued for 30 minutes. To this solution, the entire amount of 3,3′-dimethyl-4,4′-dihydroxybiphenyl solution (prepared by preparing 15 ml of a 2.2 N of aqueous sodium hydroxide solution (sodium hydroxide: 1.4 g), cooling the solution to room temperature or lower, subsequently adding 50 mg of hydrosulfite serving as an antioxidant and 1.2 g of 3,3′-dimethyl-4,4′-dihydroxybiphenyl thereto, and completely dissolving the mixture) was added, and stirring was further continued for 30 minutes.

The resulting reaction mixture was diluted in a nitrogen atmosphere with 200 mL of methylene chloride and 50 ml of water whose oxygen concentrations were separately decreased to 0.1 mg/L or less by nitrogen purging, and washing was performed. The lower layer was separated and further washed with 100 ml of water once, with 100 mL of 0.03 N hydrochloric acid once, and with 100 ml of water three times in this order. The resulting methylene chloride solution was added dropwise to methanol under stirring, and the resulting reprecipitated substance was filtered and dried to obtain a PC polymer (PC-1) having a structure below.

### Identification of PC Polymer

The PC polymer (PC-1) thus obtained was dissolved in methylene chloride to prepare a solution with a concentration of 0.5 g/dL, and a reduced viscosity [ηsp/C] at 20 degrees C. was measured (using an automatic viscosity measuring apparatus VMR-042 manufactured by RIGO Co., Ltd. with an Ubbelohde modified viscometer (model RM) for automatic viscosity). The reduced viscosity was 1.03 dL/g. The structure and the composition of the obtained PC-1 were analyzed by ¹H-NMR spectroscopy (a nuclear magnetic resonance spectrometer JNM-ECZ400S manufactured by JEOL Ltd) in terms of peak integral values derived from the constituent monomers. The results confirmed that PC-1 was a PC polymer having the following repeating units, numbers of repeating units, and composition. In the following description, “FR1” is a structural unit represented by the formula (FR1). Conditions for the ¹H-NMR spectroscopy are as follows.

### Conditions for ¹H-NMR Spectroscopy

Solvent: CD₂Cl₂
Measurement concentration (amount of sample/amount of solvent): 1.5 mg/ml
Number of scans: 64 (about 3 min)

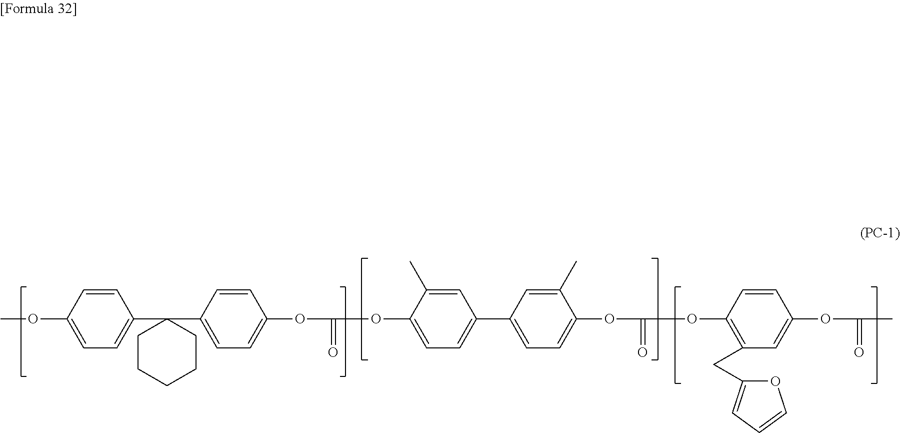

The composition ratio (mol %) is OCBP:BisZ:FR1=3:5:2.

The furan group concentration is 0.81 mmol/g.

### Synthesis Example 2

### Production of PC Polymer

A PC polymer (PC-2) having a structure below was obtained as in Synthesis Example 1 except that, in Synthesis Example 1, ZOCBP-CF was changed to Z—CF (76 mL), the amount of methylene chloride initially used was changed to 114 mL, the amount of PTBP used was changed to 0.103 g, 3,3′-dimethyl-4,4′-dihydroxybiphenyl was not used, the amount of 2-(2-furanylmethyl)hydroquinone used was changed to 6.5 g, the 1.4 N aqueous potassium carbonate solution was changed to 15 mL of a 2.8 N aqueous potassium carbonate solution (potassium carbonate: 5.9 g), the amount of triethylamine used was changed to 1.0 mL, and 15 mL of a 2.0 N aqueous NaOH solution was changed to 50 ml of a 1.6 N aqueous NaOH solution (using 3.2 g of NaOH).

### Identification of PC Polymer

The PC polymer (PC-2) thus obtained was dissolved in methylene chloride to prepare a solution with a concentration of 0.5 g/dL, and a reduced viscosity [ηsp/C] at 20 degrees C. was measured. The reduced viscosity was 1.19 dL/g. The structure and the composition of the obtained PC-2 were analyzed by ¹H-NMR spectroscopy. The results confirmed that PC-2 was a PC polymer having the following repeating units, numbers of repeating units, and composition. Conditions for the ¹H-NMR spectroscopy are as described above.

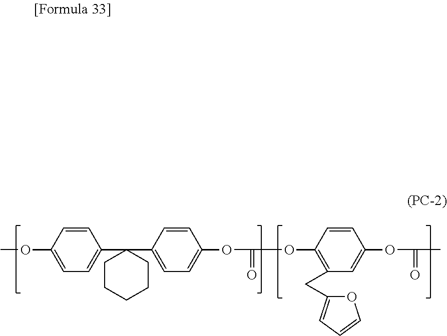

The composition ratio (mol %) is BisZ:FR1=6:4.

The furan group concentration is 1.63 mmol/g.

### Example A

### Production of Coating Material Composition and Resin Film

In a sample tube with a screw cap, 2 g of PC-1 was weighed and dissolved in 12 mL of dichloromethane to obtain a coating liquid composition. It was confirmed from the above result that the preparation of a coating material including PC-1 and an organic solvent was possible.

The resulting coating liquid composition was applied to a commercially available polyethylene terephthalate (PET) film with a thickness of 200 μm by casting using an applicator with a gap of 250 μm to form a film. The film was air-dried for one hour and treated in a vacuum dryer (degree of pressure reduction: 1 Pa to 100 Pa) at a temperature of 50 degrees C. for eight hours, and then the solvent was removed at 100 degrees C. for eight hours, thus obtaining a resin film with a thickness of the coating portion in a range from 20 μm to 30 μm. It was confirmed from the above result that the production of a resin film and a coating film including PC-1 was possible.

Further, except for replacing PC-1 with PC-2, the coating material composition was prepared and the resin film was produced as above. It was confirmed from the above result that the preparation of a coating material including PC-2 and an organic solvent was possible and that the production of a resin film and a coating film including PC-2 was possible.

### Example B1

### Production of Polymer Reactive Composition Film Formed From Copolymer and Reactive Substance

In a sample tube with a screw cap, PC-1 (2 g: 1.62 mmol) and N-phenylmaleimide (0.28 g: 1.62 mmol maleimide group) were weighed and dissolved in 12 mL of dichloromethane to obtain a coating liquid composition.

The resulting coating liquid composition was applied to a commercially available polyethylene terephthalate (PET) film with a thickness of 200 μm by casting using an applicator with a gap of 250 μm to form a film. The film was air-dried for one hour and treated in a vacuum dryer (degree of pressure reduction: 1 Pa to 100 Pa) at a temperature of 50 degrees C. for 16 hours to remove the solvent, thus obtaining a resin film with a thickness of the coating portion in a range from 20 μm to 30 μm.

### Confirmation of Reactivity of Polymer Reactive Composition

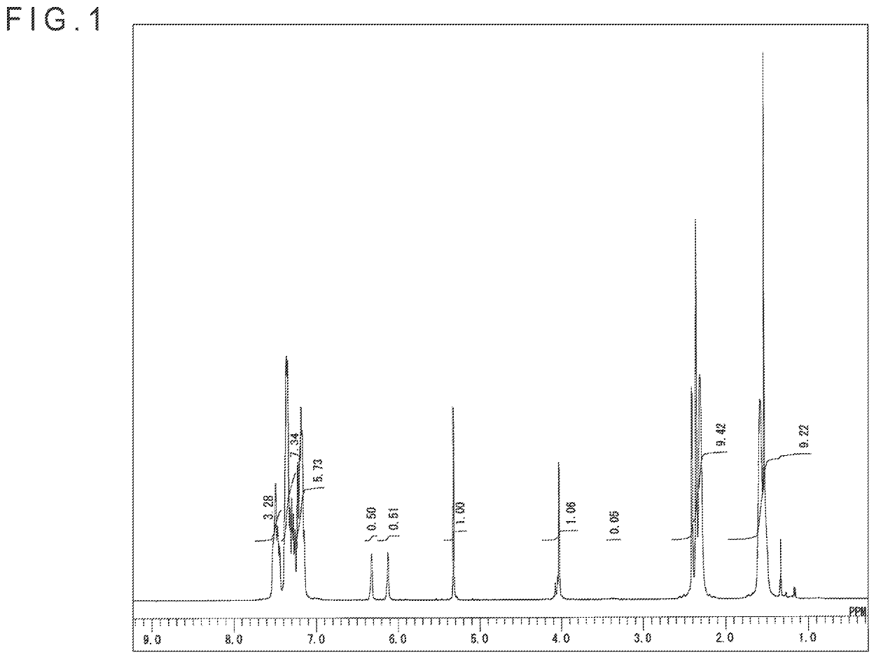

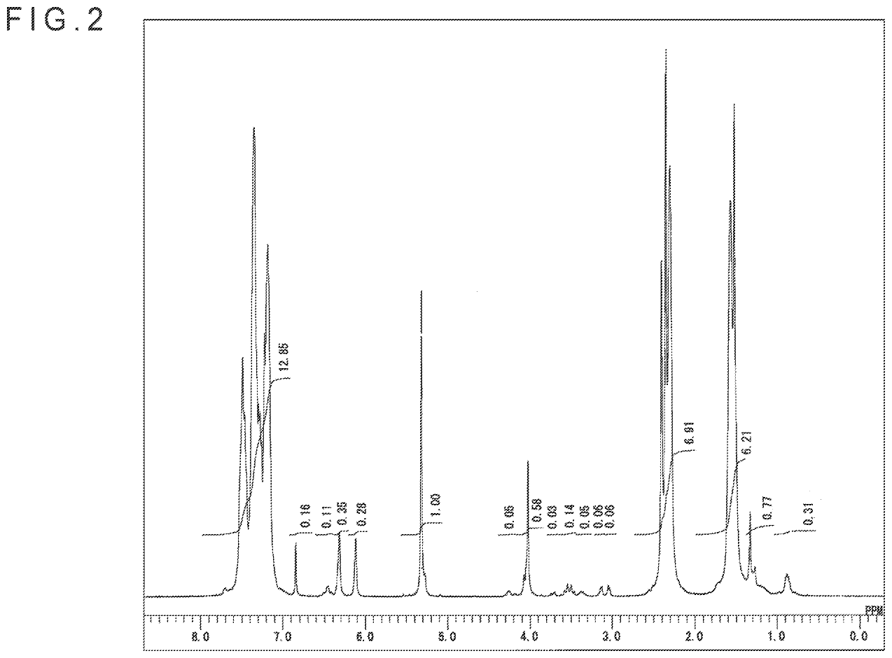

The film obtained above was treated in a vacuum dryer at a temperature of 150 degrees C. for one hour, and a structural change before and after the treatment was confirmed using ¹H-NMR. FIG. 1 is a ¹H-NMR spectrum chart of PC-1, which is a raw material resin. FIG. 2 is a ¹H-NMR spectrum chart of a polymer reactive composition. Conditions for the ¹H-NMR spectroscopy are as follows.

### Conditions for ¹H-NMR Spectroscopy

Solvent: CD₂Cl₂
Measurement concentration (amount of sample/amount of solvent): 10 mg/ml
Number of scans: 16

As new peaks not found in the raw material resin and N-phenylmaleimide, peaks in a range from 3.0 ppm to 3.8 ppm (proton bonded to a tertiary carbon newly generated by Diels-Alder reaction) and in a range from 6.4 ppm to 6.6 ppm (proton bonded to a double bond newly generated by Diels-Alder reaction) were observed, which confirmed that this resin was modifiable through the polymer reaction.

### Example B2

### Production of Polymer Reactive Composition Film Formed From Copolymer and Reactive Substance

A polymer reactive composition film was prepared in the same manner as in Example B1 except that PC-1 was changed to PC-2.

### Confirmation of Reactivity of Polymer Reactive Composition

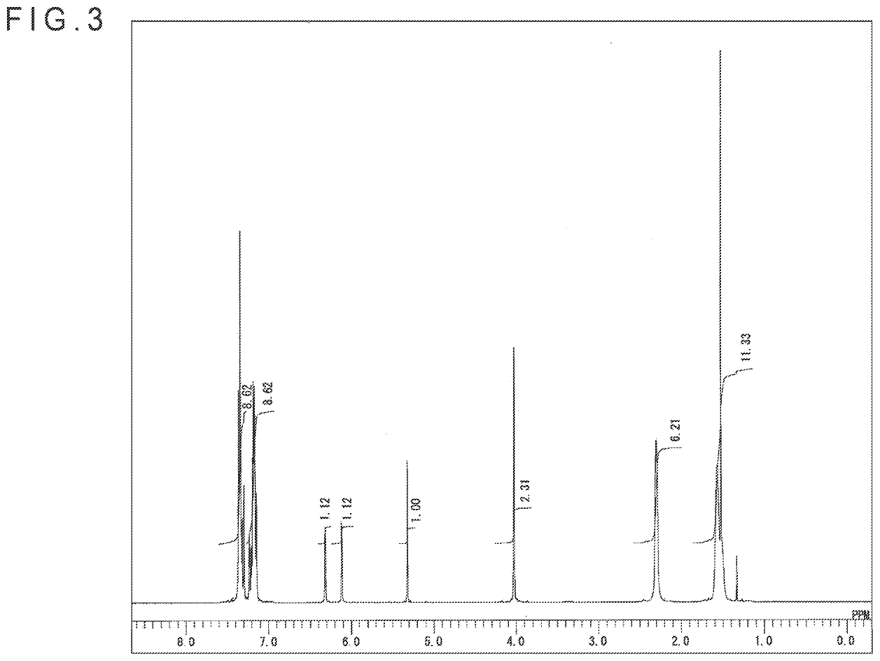

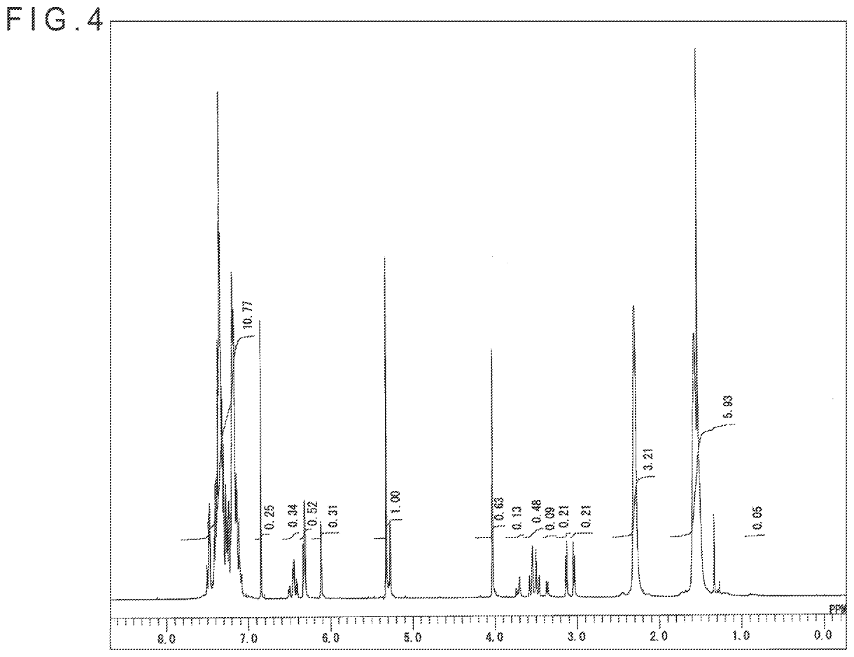

The film obtained above was treated in a vacuum dryer at a temperature of 100 degrees C. for one hour, and a structural change before and after the treatment was confirmed using ¹H-NMR. FIG. 3 is a ¹H-NMR spectrum chart of PC-2, which is a raw material resin. FIG. 4 is a ¹H-NMR spectrum chart of a polymer reactive composition. Conditions for the ¹H-NMR spectroscopy are as follows.

### Conditions for ¹H-NMR Spectroscopy

Solvent: CD₂Cl₂
Measurement concentration (amount of sample/amount of solvent): 10 mg/ml
Number of scans: 16

As new peaks not found in the raw material resin and N-phenylmaleimide, peaks in a range from 3.0 ppm to 3.8 ppm (proton bonded to a tertiary carbon newly generated by Diels-Alder reaction) and in a range from 6.4 ppm to 6.6 ppm (proton bonded to a double bond newly generated by Diels-Alder reaction) were observed, which confirmed that this resin was modifiable through the polymer reaction.

### Example C2

### Preparation of Coating Liquid for Forming Electrophotographic Photoreceptor Photosensitive Layer Including Copolymer and Reactive Substance, and Production of Multi-Layer Electrophotographic Photoreceptor

An electrophotographic photoreceptor including a multi-layer photosensitive layer was produced by sequentially stacking a charge generating layer and a charge transporting layer on a surface of an aluminum sheet used as a conductive base and having a film thickness of 100 μm. A charge generating material used was 0.5 parts by mass of Y-type oxotitanium phthalocyanine, and a binder resin used was 0.5 parts by mass of a butyral resin. These were added to 19 parts by mass of tetrahydrofuran (THF) serving as a solvent and dispersed in a ball mill. The resulting dispersion solution was applied to the surface of the conductive base film using a bar coater and dried at 70 degrees C. for 30 minutes to form the charge generating layer having a thickness of about 0.5 μm.

Next, as a coating liquid composition for the charge transporting layer, PC-2 (1 g: furanyl group, 1.63 mmol), N-phenylmaleimide (0.14 g: maleimide group, 1.62 mmol), and a charge transporting material having a structure below (CTM-1 (0.67 g)) were weighed in a sample tube with a screw cap, and dissolved in 10 ml of dichloromethane to obtain a coating liquid composition for the charge transporting layer. The resin coating liquid did not have, for example, gelation at room temperature for a week or longer and was confirmed to be stable as a coating liquid.

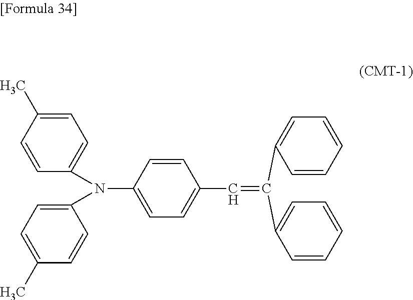 [SMILES: Cc1ccc(N(c2ccc(C)cc2)c2ccc(C=C(c3ccccc3)c3ccccc3)cc2)cc1]

The resulting coating liquid composition was applied to the charge generating layer obtained above by casting using an applicator with a gap of 375 μm to form a film. The film was air-dried for one hour and treated in a vacuum dryer (degree of pressure reduction: 1 Pa to 100 Pa) at a temperature of 50 degrees C. for 16 hours to remove the solvent, thus obtaining a resin film with a thickness of the coating portion of 30 μm.

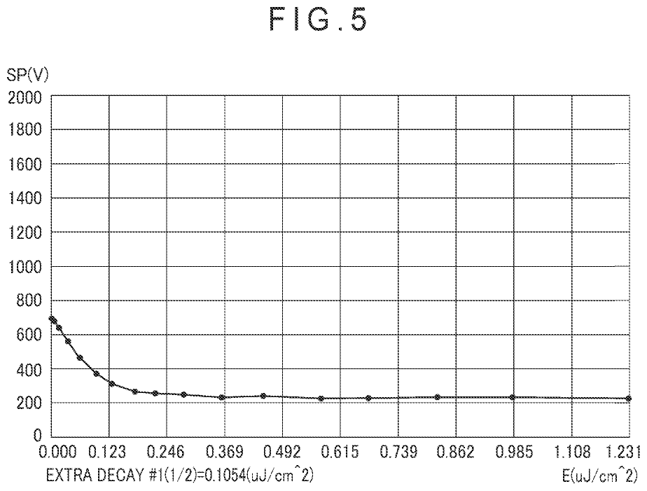

The multi-layer electrophotographic photoreceptor obtained above and a multi-layer electrophotographic photoreceptor obtained by further treating the above-obtained electrophotographic photoreceptor in a vacuum dryer at a temperature of 150 degrees C. for one hour were each attached to an aluminum drum having a diameter φ of 60 mm, and electrophotographic characteristics were evaluated in terms of light attenuation characteristics of the surface potential in the EV mode using an electrostatic charging tester CYNTHIA54IM (manufactured by GENTECH Co., Ltd.). It was confirmed that the surface potential of the obtained photoreceptor attenuated according to the amount of light and that the surface potential decreased to ½ or less of the initial amount of charge. It was thus confirmed that the composition containing PC-2 functioned as the charge transporting layer of the electrophotographic photoreceptor. FIG. 5 shows the result.

Subsequently, in order to confirm abrasion resistance of the above electrophotographic photoreceptor, a coating liquid having the same composition as that of the charge transporting layer serving as the outermost layer was prepared and applied to a commercially available polyethylene terephthalate (PET) film with a thickness of 200 μm by casting using an applicator with a gap of 250 μm to form a film. The film was air-dried for one hour and treated in a vacuum dryer (degree of pressure reduction: 1 Pa to 100 Pa) at a temperature of 50 degrees C. for 16 hours to remove the solvent, thus obtaining a resin film with a thickness of the coating portion of 20 μm.

The charge transporting composition film obtained above and a film obtained by further treating the above charge transporting composition film in a vacuum dryer at a temperature of 150 degrees C. for one hour were evaluated, using a Suga Abrasion Tester, Model: NUS-ISO-3 (manufactured by Suga Test Instruments Co., Ltd.), in terms of abrasion resistance of the cast surface of the resin film. The test conditions were as follows. While abrasion paper (containing alumina particles with a particle size of 3 μm) to which a load of 4.9 N was applied was brought into contact with the cast surface (surface simulating a surface of a photosensitive layer), a reciprocating motion was performed 800 times, and a decrease in the mass (amount of abrasion, unit: mg) was measured. Table 1 shows the results.

The film obtained above was treated in a vacuum dryer at a temperature of 150 degrees C. for one hour, and a structural change before and after the treatment was confirmed using ¹H-NMR. Conditions for the ¹H-NMR spectroscopy are as follows.

### Conditions for ¹H-NMR Spectroscopy

Solvent: CD₂Cl₂
Measurement concentration (amount of sample/amount of solvent): 10 mg/mL
Number of scans: 16

### Example C2-2

A coating film for the abrasion test was obtained as in Example C2 except that N-phenylmaleimide (0.14 g) was not used in the preparation of the charge transporting layer coating liquid used for the abrasion test. The film obtained above and a film obtained by further treating the film obtained above in a vacuum dryer at a temperature of 150 degrees C. for one hour were evaluated in terms of abrasion resistance as above. Table 1 shows the results.

### Comparative Example 1

In place of PC-2 in Example C2, polycarbonate (PCA) with a structure below of which reduced viscosity [ηsp/C] at 20 degrees C. was 1.19 dL/g with use of a solution with a concentration of 0.5 g/dL was used to prepare a charge transporting layer composition film. Then, abrasion resistance was evaluated as above. Table 1 shows the results.

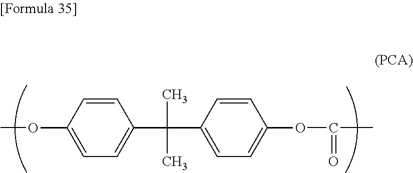

TABLE 1

| | | | Abrasion amount | Abrasion amount |
|---|---|---|---|---|
| | | | [mg] before heating | [mg] after heating |
| | Resin | Reactant | at 150 degrees C. | at 150 degrees C. |
| Example C2 | PC-2 | PMI | 1.01 | 0.76 |
| Example C2- | PC-2 | None | — | 0.82 |
| 2 | | | | |
| Comparative | PCA | None | — | 1.04 |
| Example 1 | | | | |

The abrasion amount of Example C2 (after heating at 150 degrees C.) was 7% lower than that of Example C2-2 (after heating at 150 degrees C.).

In Example C2, the abrasion amount was reduced by 25% due to the reaction between the polymer and the low molecular weight compound by heating at 150 degrees C., and this confirmed that the abrasion resistance of the reactive resin was excellent.

The abrasion amount of Example C2-2 was 21% lower than that of Comparative Example 1, and this confirmed that this resin had excellent abrasion resistance.

Further, a structural change of the charge transporting layer film obtained in Example C2 before and after the heat treatment was confirmed in 1H-NMR. As a result, it was confirmed that a new peak in a range from 3.0 ppm to 3.8 ppm (proton bonded to a tertiary carbon newly generated by Diels-Alder reaction), which was not found in the raw material resin and N-phenylmaleimide, was observed as in the changes in FIGS. 1 and 2, and thus was confirmed that this resin was modifiable through the polymer reaction.

1. A resin comprising a repeating unit of a structure represented by a formula (FR1) below; 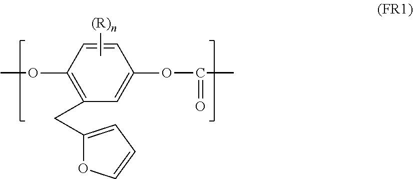
where, in the formula (FR1):
R are each independently an aliphatic hydrocarbon group having 1 to 6 carbon atoms, an aromatic hydrocarbon group having 6 to 12 ring carbon atoms, an alkoxy group having 1 to 10 carbon atoms, or a halogen atom;
a plurality of R are optionally linked together to form a cyclic structure (comprising an aromatic ring and a heterocycle); and
n represents an integer in a range from 0 to 3.

2. The resin according to claim 1, wherein the resin is at least one resin selected from the group consisting of an aromatic polycarbonate and a polyarylate.

3. The resin according to claim 1, wherein the resin comprises a structure represented by a formula (S1) below, 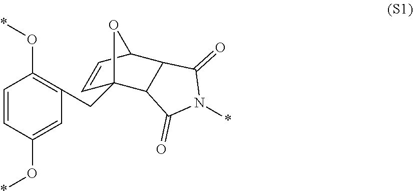 [SMILES: *Oc1ccc(O*)c(CC23C=CC(O2)C2C(=O)N(*)C(=O)C23)c1]
where, in the formula (S1), * each represent a bonding position.

4. A resin composition comprising the resin according to claim 1.

5. A resin composition comprising:
the resin according to claim 1; and
a compound comprising a dienophile structure or a resin comprising a dienophile structure.

6. The resin composition according to claim 5, wherein the dienophile structure comprises a structure represented by a formula (DP1) below, 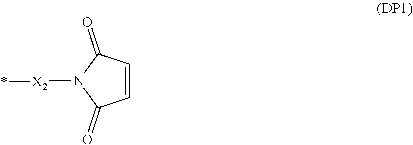
where, in the formula (DP1):
X₂ is a single bond or a linking group to another skeleton;
X₂ serving as the linking group is a group which comprises at least one atom selected from the group consisting of a carbon atom, an oxygen atom, a nitrogen atom, a sulfur atom, a silicon atom, a phosphorus atom, and a boron atom and in which bonding forms between atoms constituting the linking group are each a covalent bond; and
* represents a bonding position.

7. The resin composition according to claim 6, wherein the dienophile structure comprises a structure represented by a formula (DP2) below, 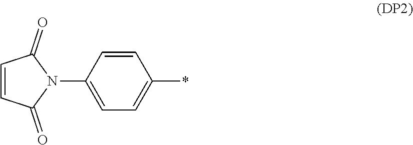 [SMILES: *c1ccc(N2C(=O)C=CC2=O)cc1]
where, in the formula (DP2), * represents a bonding position.

8. The resin composition according to claim 5, wherein the resin comprising the repeating unit of the structure represented by the formula (FR1), which is either an aromatic polycarbonate comprising a repeating unit constituted by a repeating unit A represented by a formula (1) below alone or an aromatic polycarbonate comprising the repeating unit A represented by the formula (1) and a repeating unit B represented by the formula (2), is a polymer represented by a formula (100) below, 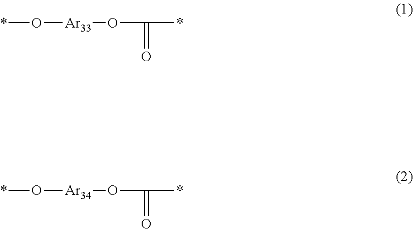
where, in the formula (1), Ar₃₃ is a divalent benzene ring residue in a group represented by the formula (FR1);
in the formula (2), Ar₃₄ is a group represented by a formula (UN11) below; and
in the formulae (1) and (2), * each represent a bonding position, 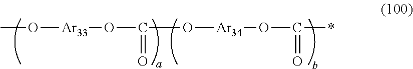
where, in the formula (100), a represents a molar copolymerization ratio in the repeating unit A, and b represents a molar copolymerization ratio in the repeating unit B;
a is [Ar₃₃]/([Ar₃₃]+[Ar₃₄]), b is [Ar₃₄]/([Ar₃₃]+[Ar₃₄]), and a case where b is 0 is also included; and [Ar₃₃] represents the number of moles of the repeating unit A comprising a group represented by Ar₃₃ in the PC polymer, and [Ar₃₄] represents the number of moles of the repeating unit B comprising a group represented by Ar₃₄ in the PC polymer, 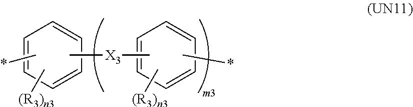
where, in the formula (UN11):
m3 is 0, 1 or 2;
n3 is 4;
a plurality of R₃ are each independently a hydrogen atom, a halogen atom, an alkyl having 1 to 10 carbon atoms, an aryl having 6 to 12 ring carbon atoms, or a fluorinated alkyl having 1 to 10 carbon atoms;
X₃ are each independently a group constituted by one or two or more selected from the group consisting of a single bond, —C(—R₃₁)₂—, —O—, —S—, —SO—, —SO₂— —N(—R₃₂)—, —P(—R₃₃)—, —P═O(—R₃₄)—, a carbonyl, an ester, an amide, an alkylene having 2 to 20 carbon atoms, an alkylidene having 2 to 20 carbon atoms, a cycloalkylene having 3 to 20 ring carbon atoms, a cycloalkylidene having 3 to 20 ring carbon atoms, an arylene having 6 to 20 ring carbon atoms, a bicycloalkanediyl having 4 to 20 ring carbon atoms, a tricycloalkanediyl having 5 to 20 ring carbon atoms, a bicycloalkylidene having 4 to 20 ring carbon atoms, and a tricycloalkylidene having 5 to 20 ring carbon atoms;
R₃₁ to R₃₄ are each independently a hydrogen atom, a halogen atom, an alkyl having 1 to 10 carbon atoms, an aryl having 6 to 12 ring carbon atoms, or a fluorinated alkyl having 1 to 10 carbon atoms; and
* each represent a bonding position.

9. The resin composition according to claim 5, wherein the resin composition comprises one component selected from a component (i), a component (ii), and a component (iii) below,
(i) a polymer having the structure represented by the formula (FR1) in a polymer chain, and a compound having a dienophile group,
(ii) a polymer having the structure represented by the formula (FR1) in a polymer chain, and a polymer having the dienophile structure in a polymer chain, and
(iii) a polymer having both the structure represented by the formula (FR1) and the dienophile structure in a single polymer chain.

10. A coating liquid composition comprising the resin composition according to claim 5, and an organic solvent.

11. A film comprising the resin according to claim 1.

12. A coating film comprising the resin according to claim 1.

13. An electrophotographic photoreceptor comprising the resin according to claim 1.

14. An insulative material comprising the resin according to claim 1.

15. A molded product comprising the resin according to claim 1.

16. An electronic device comprising the resin according to claim 1.

17. A method of producing a resin comprising heating the resin composition according to claim 9 to conduct a polymer reaction of the resin composition.
